(19) United States
(12) Patent Application Publication
(10) Pub. No.: US 2025/0182123 A1
(43) Pub. Date: Jun. 5, 2025

(54) PRIVACY-PRESERVING DETECTION FOR DIRECTIONAL ELECTRONIC COMMUNICATIONS

(71) Applicant: VISA INTERNATIONAL SERVICE ASSOCIATION, San Francisco, CA (US)

(72) Inventors: Sourav Das, Champaign, IL (US); Srinivasan Raghuraman, Cambridge, MA (US); Mahdi Zamani, Mercer Island, WA (US); Ranjit Kumaresan, Fremont, CA (US); Mohammad Mohsen Minaei Bidgoli, San Jose, CA (US); Sebastian Meiser, Lübeck (DE); Mihai Christodorescu, Belmont, CA (US); Wanyun Gu, Menlo Park, CA (US); Yibin Yang, San Francisco, CA (US)

(73) Assignee: VISA INTERNATIONAL SERVICE ASSOCIATION, San Francisco, CA (US)

(21) Appl. No.: 18/845,853

(22) PCT Filed: Mar. 29, 2023
(86) PCT No.: PCT/US2023/016695

§ 371 Date: Sep. 10, 2024

Related U.S. Application Data
(60) Provisional application No. 63/331,706, filed on Apr. 15, 2022.

(51) Int. Cl. G06Q 20/40

(52) U.S. Cl. CPC G06Q 20/4016

(57) ABSTRACT

Embodiments are directed to methods and systems that can be used to perform efficient, parallel, privacy-preserving graph analysis. One particular application of embodiments is performing private cycle detection in order to detect anomalous behavior in directional electronic communications. Two (or more) parties can each possess private electronic communication data, which can be used to construct a private directed union graph corresponding to the union of the parties' electronic communication data. This private union graph can be analyzed by a multi-party computation network in order to detect cycles of defined length (e.g., comprising between four and eight communicating participants). These cycles can be used as evidence of anomalous or illicit use of such electronic communications systems.

### CROSS REFERENCE TO RELATED APPLICATIONS

This application is an international patent application which claims the benefit of the filing date of U.S. Patent Application No. 63/331,706 filed Apr. 15, 2022, which is herein incorporated by reference in its entirety for all purposes.

### BACKGROUND

Directional electronic communications are common in networked systems such as the Internet or financial networks. Often, such communications are part of normal, legitimate interactions between individuals, computer systems, or other entities (e.g., businesses). However, such communications can also be part of illegitimate or illegal activities. For example, Distributed Denial of Service (DDOS) attacks and wire fraud are illegal activities that often involve directional electronic communications.

Directional electronic communications can be represented by graphs, data structures comprising vertices (or nodes) connected by directed edges. In such structures, vertices may represent individuals or other entities and edges may represent directed electronic communications. By analyzing patterns in the structure of these graphs, it is possible to detect anomalous, fraudulent, or illegal activities. For example, analyzing patterns in Internet communication graphs can be used to detect DDOS attacks. As another example, analyzing patterns in a graph of electronic financial transfers (e.g., wire transfers) can be used to detect fraud or financial crimes.

In many cases directional electronic communication data, which may be used to construct a graphical representation, may not be held by any single party. Instead, such data may be distributed among a number of parties. For example, two banks may possess financial transfer data corresponding to electronic wire transfers between their customers and other individuals or entities. These banks could conceivably share their respective financial transfer data in order to construct a graph representing wire transfers among their customers.

However, in many cases, parties cannot share their respective directional electronic communication data with one another because the data may be sensitive or confidential. For example, two hospitals may be unable to share internal medical communication data with one another, as it may contain patient health information. As another example, two banks may be unwilling to share electronic communication data relating to financial transfers with one another, as such data may violate their customers' privacy. As such, parties are often unable to share the electronic communication data necessary to construct a corresponding graph. This in turn prevents graph based analysis of directional communications.

Thus, there is a need for privacy-preserving and efficient methods of collaboratively performing graph analysis, particularly on graphs corresponding to directional electronic communications.

### SUMMARY

Embodiments of the present disclosure relate to efficient, parallel, computerized, and privacy-preserving methods of graph analysis. Embodiments enable two or more parties to collectively analyze a secret-shared union graph constructed from a union of the parties' private data using multi-party computation. One advantage of embodiments is that the parties can perform this graph analysis without sharing their private data with one another. Another advantage of embodiments is that these methods enable computer systems or networks to perform private graph analysis faster and using less operations than conventional private graph analysis techniques. Although this disclosure primarily discusses graph analysis of directional electronic communications (e.g., communications between computer systems in a network such as the Internet, or communications in financial systems such as electronic banking systems or credit card networks), embodiments can be used to perform a wide variety of private graph analysis techniques on nearly any data that can be represented graphically.

Some embodiments are directed to methods of performing private cycle detection on union graphs using the aforementioned methods and techniques. Particularly, such embodiments are directed to performing private cycle detection on union graphs of financial transfer data for the purpose of detecting money laundering. These methods enable multiple parties (e.g., banks) to detect money laundering activities across their respective financial domains, without revealing sensitive financial transfer data to one another, thereby protecting the privacy of their clients or other stakeholders.

Embodiments of the present disclosure are described in the detailed description below with reference to two primary phases. A setup phase broadly comprises steps that prepare data for later private multi-party graph analysis. In the setup phase, each party's computer system (e.g., a first party computer, a second party computer, etc.) can prepare their data by forming tuple lists (e.g., a first tuple list corresponding to a first party and a second tuple list corresponding to a second party) that represents their respective data in graphical form. The parties can then use cryptographic techniques such as garbled circuits to generate a secret-shared union tuple list. No party has plaintext access to the secret-shared union tuple list, and as such, no party can access the other parties' private data. In the computation phase, a multi-party computation network (which may include the first party computer, the second party computer, etc.) can perform a multi-party graph analysis method. This multi-party graph analysis method can produce a result that can be transmitted back to the first party computer and the second party computer. For example, if the graph analysis methods is used to detect cycles in a union graph comprising financial transfer data, the result could comprise a plaintext list of these cycles. Alternatively or additionally, the result could comprise notification of money laundering, evidenced by the detection of cycles in the financial transfer data.

One embodiment is directed to a method of detecting money laundering performed by a multi-party computation network. The multi-party computation network can receive a secret-shared union tuple list from a first party computer and a second party computer. The secret-shared union tuple list can be generated by the first party computer and the second party computer using a first tuple list corresponding to first financial transfer data and the first party computer, and a second tuple list corresponding to second financial transfer data corresponding to the second party computer. The secret-shared union tuple list can comprise a plurality of secret-shared union tuples corresponding to a representation of a union graph. The multi-party computation network can detect one or more cycles in the secret-shared union tuple list by performing a multi-party computation on the secret-shared union tuple list, the one or more cycles comprising one or more directed cycles in the union graph. The multi-party computation network can provide a notification of money laundering to the first party computer and the second party computer in response to detecting the one or more cycles.

Another embodiment is directed to a method of executing a parallel private graph method performed by a multi-party computation network. The multi-party computation network can receive a secret shared union tuple list from a first party computer and a second party computer. The secret-shared union tuple list can be generated using a first tuple list corresponding to the first party computer and a second tuple list corresponding to the second party computer. The secret-shared union tuple list can comprise a representation of a union graph. The multi-party computation network can generate a first permutation corresponding to a first ordering and a second permutation corresponding to a second ordering. The first permutation can enable the multi-party computation network to order the secret-shared union tuple list according to the first ordering and the second permutation can enable the multi-party computation network to order the secret-shared union tuple list according to the second ordering. The multi-party computation network can define a set of inputs as a plurality of secret-shared union tuples in the secret-shared union tuple list. The multi-party computation network can execute the parallel private graph method using an iterative Scatter-Gather-Apply approach, the iterative Scatter-Gather-Apply approach comprising an upward pass, a downward pass, and an apply step. The upward pass can comprise: (1) dividing the set of inputs among a plurality of processors; (2) processing the set of inputs based on the parallel private graph method and a current ordering of the secret-shared union tuple list using the plurality of processors, thereby producing a set of outputs, wherein the set of outputs comprises less outputs than the set of inputs comprises inputs; (3) defining the set of inputs as the set of outputs; and (4) repeating the upward pass until the set of inputs comprises a single input. The downward pass can comprise: (5) dividing the set of inputs among the plurality of processors; (6) processing the set of inputs based on the parallel private graph method and the current ordering of the secret-shared union tuple list using the plurality of processors, thereby producing the set of outputs, wherein the set of outputs comprises more outputs than the set of inputs comprises inputs; (7) defining the set of inputs as the set of outputs; and (8) repeating the downward pass until the set of inputs comprises an updated plurality of union tuples in the secret-shared union tuple list. The apply step can comprise: (9) dividing the updated plurality of union tuples among the plurality of processors; (10) applying an apply function to each tuple of the updated plurality of union tuples using the plurality of processors, wherein the apply function produces a result of the parallel private graph method if a terminating condition has been achieved, the terminating condition indicating that the parallel private graph method has been completed; and (11) determining whether the terminating condition has been achieved. If the terminating condition has not been achieved, and if the secret-shared union tuple list is in the first ordering, the multi-party computation network can obliviously shuffle the secret-shared union tuple list into the second ordering using the second permutation, otherwise the multi-party computation network can obliviously shuffle the secret-shared union tuple list into the first ordering using the first permutation. The multi-party computation network can repeat the iterative Scatter-Gather-Apply approach until the terminating condition has been achieved.

These and other embodiments of the disclosure are described in detail below. For example, other embodiments are directed to systems, devices, and computer readable media associated with methods described herein.

### TERMS

A “server computer” may refer to a powerful computer or cluster of computers. For example, a server computer can include a large mainframe, a minicomputer cluster, or a group of servers functioning as a unit. In one example, a server computer can include a database server coupled to a web server. A server computer may comprise one or more computational apparatuses and may use any of a variety of computing structures, arrangements, and compilations for servicing the requests from one or more client computers.

A “memory” may refer to any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or XScale; and/or the like processor(s).

An “identifier” may refer to data that can be used to identify something. Examples of identifiers include names and identification numbers. Identifiers can be used to identify things uniquely or relatively. As an example, for a “first list,” “second list,” and “third list,” the terms “first,” “second,” and “third,” may comprise identifiers used to identify the respective lists.

A “union” may refer to a collection of elements from two or more groups or sets. The union of sets [1, 2, 3] and [3, 4, 5] may comprise the set [1, 2, 3, 4, 5].

A “disjoint” may refer to all elements from one set that are not included in another set. The disjoint of sets [1, 2, 3] and [3, 4, 5] may comprise the set [1, 2] or the set [4, 5].

A “graph” may refer to a structure used to represent data. A graph may comprise “vertices” and “edges.” In a graph, vertices (usually represented as points) may be connected by edges (usually represented as lines). In a “directed graph” the edges may have a direction, such that they point from one connected vertex to another connected vertex. In directed graphs, edges may be represented by arrows. A “union graph” may refer to a graph comprising the union of two or more other graphs. A “data-augmented graph” may refer to a graph in which vertices and edges may have associated data, such as weights associated with edges or identifiers associated with vertices.

A “cycle” may refer to a structure within a graph comprising some number of vertices connected by edges in a closed loop. A “directed cycle” may refer to a similar structure in a directed graph, in which directed edges form a closed loop and are all oriented in the same direction.

A “cycle detection method” may refer to a method or function used to detect cycles in a graph. Examples include Dijkstra's method and the Rocha-Thatte cycle detection method.

“Secret sharing” may refer to techniques used to distribute data (sometimes referred to as a “secret”) among a group of participants, such that each participant receives a “share” of the “secret-shared data.” Typically, no single party has access to the data, but some group of parties possessing some number of secret shares can collectively reconstruct the data using their respective shares.

“Multi-party computation” may refer to computations performed by multiple parties, usually using some combination of data belonging to each participant individually. A “secure” multi-party computation may refer to a multi-party computation that does not leak or otherwise reveal the parties' data while the computation is being performed. Secret sharing techniques can be used, in part, to implement multi-party computation.

A “tuple” may refer to a collection of elements (e.g., data values) of some length. For example a “3-tuple” may comprise the elements [A, 3.2, FALSE]. A tuple may be used to represent some other data or object. For example, a “vertex tuple” may be used to represent a vertex in a graph. Likewise, an “edge tuple” may be used to represent an edge in a graph. A “tuple list” may comprise an ordered list of tuples.

“Financial transfer data” may refer to data corresponding to financial transfers performed by individuals or groups. For example, financial transfer data may correspond to a money transfer performed between a first individual and a second individual. Financial transfer data may include data or information associated with a financial transfer, such as identifiers associated with the participants in the transfer, a monetary amount, a timestamp corresponding to the time that the transfer took place, etc.

A “notification” may refer to a message used to notify an entity of something. For example, a “notification of completion” may comprise a message used to notify an entity that something (e.g., a method or function) has been completed.

A “garbled circuit” or “garbled circuit protocol” may refer to a cryptographic model used to securely evaluate functions. A garbled circuit may comprise an emulation of a Boolean circuit, which when evaluated, performs the function associated with the Boolean circuit without revealing the inputs to the function to the evaluator. Garbled circuits may be used to implement a variety of secure computations, including secure multi-party computations.

“Private set intersection” may refer to multi-party computation techniques used to compute the intersection of two sets (often belonging to two different parties) without revealing each party's respective set to the other party.

An “ordering” may refer to a particular order of a group of elements. For example, for the list of elements [A, B, C, D], a first ordering can comprise [B, A, D, C] and a second ordering can comprise [D, C, A, B]. A “permutation” may refer to a way in which a set of elements can be ordered or arranged. A permutation may be used to define an ordering. For example, the permutation [1, 2, 3, 4] may define the ordering [A, B, C, D], while the permutation [4, 3, 2, 1] may define the ordering [D, C, B, A].

An “oblivious function” may refer to a function that operates on some input, for which the executor of the function (e.g., a multi-party computation network) remains oblivious about the data being operated on. For example, a computer system performing “oblivious sorting” may sort a list of data elements in ascending or descending order, without learning any information about the data elements being sorted. Likewise, a computer system performing “oblivious shuffling” may shuffle a list of data elements according to a permutation, without learning any information about the data elements being shuffled.

A “terminating condition” may refer to a condition under which something (e.g., a function or method) terminates or end. A “halting condition” may refer to a condition under which something (e.g., a function or method) halts. The terms “terminating condition” and “halting condition” may be used somewhat interchangeably.

### BRIEF DESCRIPTION OF THE DRAWINGS

FIG. 1 shows an exemplary graph used to describe some methods according to embodiments.

FIG. 2 shows a first exemplary multi-party computation network according to some embodiments.

FIG. 3 shows a second exemplary multi-party computation network according to some embodiments.

FIG. 4 shows a diagram used to describe garbled circuits.

FIG. 5 shows a method of privately constructing a secret-shared union tuple list according to some embodiments.

FIG. 6 shows a diagram used to describe the Rocha-Thatte cycle detection method.

FIG. 7 shows a flowchart corresponding to a setup phase of some methods according to embodiments.

FIG. 8 shows a diagram detailing a process used to generate a secret-shared union tuple list according to some embodiments.

FIG. 9 shows a diagram detailing a process used to determine permutations corresponding to orderings of a secret-shared tuple list.

FIG. 10 shows a diagram summarizing a method used to perform graph analysis on a secret-shared union tuple list according to some embodiments.

FIG. 11 shows a flowchart corresponding to a Scatter-Gather-Apply phase of a method according to embodiments.

FIG. 12 shows a diagram of an upward pass according to some embodiments.

FIG. 13 shows a diagram of a downward pass according to some embodiments.

FIG. 14 shows a diagram of a parallelized shuffling protocol according to some embodiments.

FIG. 15 shows an exemplary computer system according to some embodiments.

### DETAILED DESCRIPTION

As summarized above, some embodiments of the present disclosure are directed to methods and systems for performing parallel, private, multi-party graph analysis. Computer systems corresponding to participating parties (e.g., a first party computer, and a second party computer), each possessing their own respective data (e.g., first party financial transfer data and second party financial transfer data), can communicate with a multi-party computation network in order to perform parallel, private, multi-party graph analysis on the union of the parties' data, for the purpose of, for example, detecting cycles that may be indicative of money laundering or other fraud. Methods according to embodiments can involve, generally, a setup phase and a computation phase, which are summarized in some detail below.

The setup phase broadly comprises steps performed to prepare the parties' data for processing in the computation phase. The computation phase involves a multi-party computation network using the prepared data to privately compute the output of some form of graph analysis. The description herein primarily focuses on cycle detection, particularly cycle detection for the purpose of detecting evidence of money laundering in financial transfer graphs. However, some embodiments can be used in other graph analysis applications, such as constructing word frequency histograms, network ranking systems, or performing private matrix factorization, as described in Section F below. In the case of cycle detection for detecting money laundering, the output of the graph analysis, performed in the computation phase, can comprise a notification of money laundering activities (e.g., indicating whether evidence of money laundering has been detected), which can further comprise a plaintext list of one or more detected cycles.

In more detail, the setup phase can involve two (or more) computers, each associated with a respective party, constructing a secret-shared union tuple list corresponding to their collective data. This secret-shared union tuple list can correspond to a union graph, a graphical representation of the parties' collective data. The secret-shared union tuple list can be secret-shared such that neither party can read or interpret the data in the secret-shared union tuple list in plaintext. As such, no party has access to the other parties' data. The secret-shared union can then be evaluated by a multi-party computation network using parallel multi-party computation techniques, in order to e.g., identify cycles in the union graph for the purpose of detecting money laundering.

In the setup phase, a first party computer associated with a first party and a second party computer associated with a second party, can each represent their respective data (e.g., first party data and second party data) as a first party tuple list and a second party tuple list respectively. Each “tuple” in these tuple lists comprises a collection of data, and represents a particular graph element (e.g., a vertex or an edge) in the union graph. The first tuple list and the second tuple list can be input into a union garbled circuit, in order to construct the secret-shared union tuple list.

Afterwards, the secret-shared union tuple list can be obliviously sorted in order to determine a first permutation and a second permutation, corresponding to a first ordering of the secret-shared union tuple list and a second ordering of the secret-shared union tuple list.

These permutations may be used in the computation phase to obliviously shuffle the secret-shared union tuple list between the first ordering and the second ordering. The purpose of this shuffling is described in greater detail in Section E below, but generally, obliviously sorting or shuffling the union tuple list is part of an iterative process used to determine the output (e.g., a list of cycles) of the multi-party computation. As such, determining the permutations in advance, during the setup phase, reduces the number of operations that are performed during the computation phase, thereby improving the speed and efficiency of some methods according to embodiments.

In more detail, during the computation phase, a multi-party computation network, comprising a first server computer, a second server computer, and a third server computer, can divide the secret-shared union tuple list among a pool of processors. Dividing the secret-shared union tuple list among the pool of processors enables the graph analysis method (e.g., the cycle detection method) to be performed in parallel, increasing the speed and efficiency.

The multi-party computation network, operating the pool of processors, can then perform an iterative, private, parallel, multi-party, Scatter-Gather-Apply (SGA) method in order to perform graph analysis on the secret-shared union tuple list. SGA is described in more detail in Section C below, and specific details on this iterative process are described in Section E below.

Broadly, in each iteration, the multi-party computation network obliviously shuffles the secret-shared union tuple list using the first permutation such that it is in the first ordering. Subsequently, the multi-party computation network performs a Scatter-Gather step, then an Apply step. Collectively, performing these two steps results in updating data associated with the union tuple list, data which can be used to both produce the output of the SGA method (e.g., the list of cycles) and can be used to determine when the SGA method has been completed. Afterwards, the multi-party computation network can obliviously shuffle the secret-shared union tuple list using the second permutation, such that the secret-shared union tuple list is in the second ordering, and the Scatter-Gather step, and Apply step can be performed again. This process can be repeated, alternating between the first ordering and the second ordering, until some terminating condition has been met, at which point the multi-party computation network can output, e.g., a plaintext list of cycles to the first party computer and the second party computer.

### A. Example Graphs

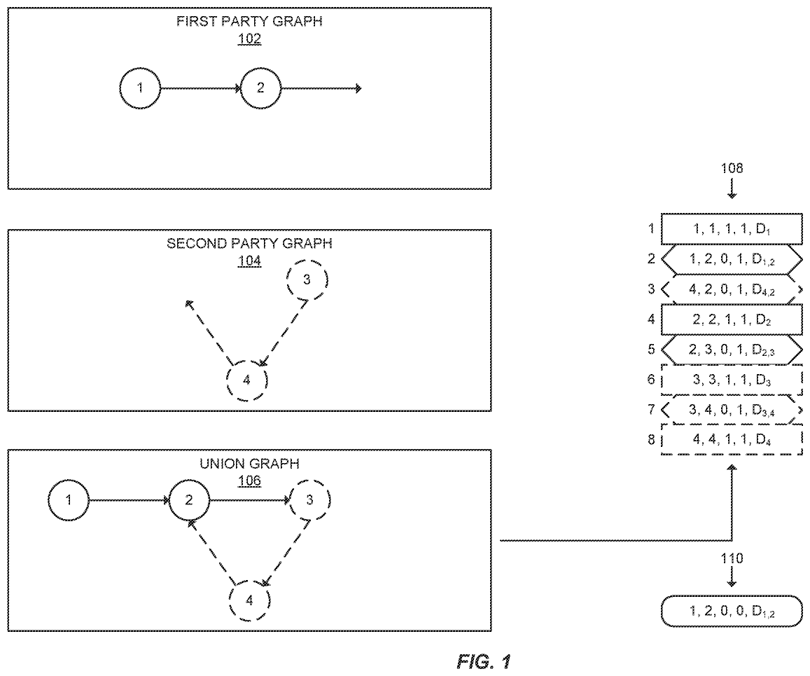

The majority of this disclosure will focus on a particular use case corresponding to the detection of cycles in private union graphs, more specifically, private union graphs corresponding to financial transfer data. To this end, FIG. 1 displays three graphs that will be used as examples throughout the disclosure. The first party graph 102 can correspond to a first party (e.g., a first bank) and the second party graph 104 (rendered with dashed lines) can correspond to a second party (e.g., a second party bank). The union graph 106 contains one cycle comprising vertices 2, 3, and 4.

In some embodiments, the union graph can comprise a union financial transfer graph corresponding to first party financial transfer data corresponding to the first party and second party financial transfer data corresponding to the second party. In such a case, each vertex can correspond to an individual, business, or other entity, and each edge can correspond to a financial transfer from that individual to another individual. The two parties corresponding to the first party graph and the second party graph may want to detect cycles in their union graph for the purpose of detecting money laundering activities. However, the two parties may not want to reveal their private financial transaction data to one another. Hence the two parties can use embodiments of the present disclosure to construct the union graph 106 in secret-shared form, enabling a multi-party computation network efficiently process the union graph 106 to detect any cycles therein. The multi-party computation network (described below in Section B) can produce a list of one or more cycles corresponding to the union graph. These cycles can comprise one or more cyclical payments between entities corresponding to the vertices in the union graph (e.g., entities corresponding to vertices 2, 3, and 4), which may comprise evidence of money laundering activities.

FIG. 1 also shows an exemplary union tuple list 108 comprising vertex tuples and edge tuples. The vertex tuples are represented by rectangles with sharp corners and the edge tuples by wide hexagons. FIG. 1 also shows a duplicate edge tuple 110, represented by a rectangle with rounded corners. This representation and these elements are described in further detail below in Section C.

Generally, a secret-shared union tuple list, comprising a representation of a union graph (such as union graph 106), can be analyzed by a multi-party computation network in order to detect one or more cycles in the secret shared union tuple list, the one or more cycles comprising or corresponding to one or more cycles in the union graph 106 (e.g., the cycle between vertices 2, 3, and 4). A secret-shared union tuple list can comprise a plurality of secret shared vertex tuples representing a plurality of vertices in the union graph and a plurality of secret-shared edge tuples representing a plurality of edges in the union graph. A union tuple list (such as union tuple list 108) can be secret-shared among computers in a multi-party computation network using a secret sharing technique, such as the replicated secret sharing technique of Araki, et al. [14]. This secret sharing process can enable the multi-party computation network to detect cycles in the secret-shared union tuple list, without revealing either party's data.

The tuple list form is useful because it enables the union graph 106 to be analyzed using linear scan operations, which can be parallelized by distributing the secret shared tuples in the secret-shared union tuple list among processors associated with the multi-party computation network.

As described below in Section D, each party (e.g., the first party and the second party) can represent the first party graph 102 and the second party graph 104 as a first tuple list and a second tuple list, then combine those tuple lists (using, for example, a union garbled circuit, as described in Section C), to produce the secret-shared union tuple list comprising a plurality of secret shared union tuples corresponding to a representation of the union graph 106, which can then be transmitted to the multi-party computation network and analyzed to privately detect cycles.

It should be understood that the example graphs of FIG. 1 have been intentionally simplified for the purpose of illustration. In many real world applications, such graphs can be considerably larger and more complex, and may (in some cases) not contain any hanging edges, such as the directed edge on vertex 2 of the first party graph 102 or the directed edge on vertex 4 of the second party graph 104.

It should be understood that many improvements or advantages provided by embodiments of the present disclosure are not limited solely to the context of cycle detection in private union financial transfer graphs. Embodiments of the present disclosure can also be used to detect cycles in other forms of private graphs, such as private software graphs (e.g., for the purpose of detecting deadlock in distributed systems). Some embodiments can also be used to improve the speed and efficiency of other private graph processes or applications. For example, as described below in Section F, some embodiments can be used to perform private word counting, implement efficient network ranking systems, or perform matrix factorization on private union graphs.

### B. System Model

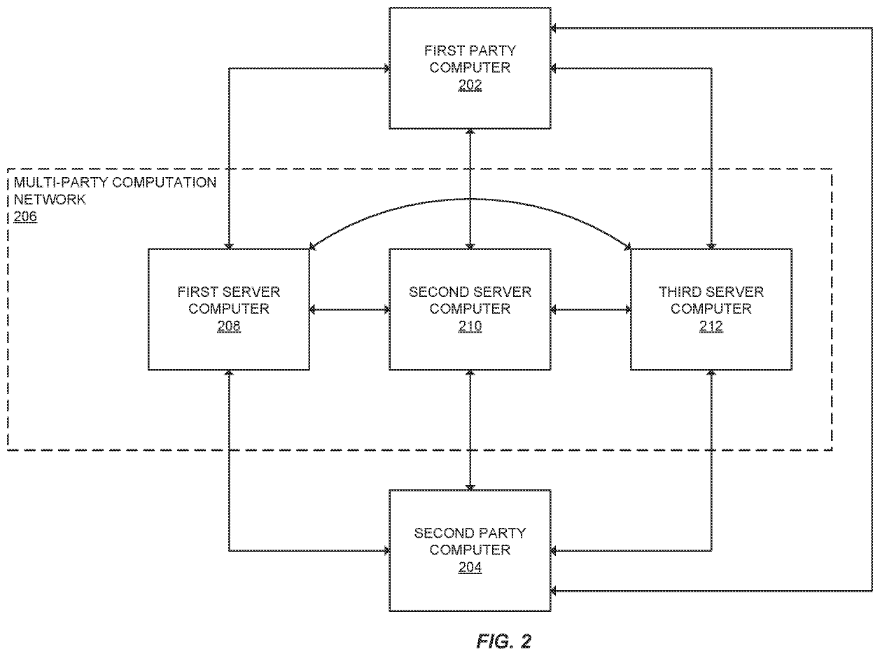

Prior to describing methods according to embodiments in more detail, it may be helpful to describe a multi-party computation network that can be used to perform parallel private graph analysis, such as, e.g., detecting money laundering in financial transfer graphs by performing cycle detection on a secret-shared union tuple list. FIG. 2 shows a diagram of an exemplary system according to some embodiments. This exemplary system comprises two client computers: a first party computer 202 and a second party computer 204, as well as a multi-party computation network 206 (sometimes referred to as a secret-sharing network). In some embodiments, the multi-party computation network 206 may comprise a three-party honest majority semi-honest multi-party computation network, which may collectively

execute three-party secret sharing and computation schemes, such as Araki et al. [14]. As such, the multi-party computation network can comprise a first server computer 208, a second server computer 210, and a third server computer 212. These server computers may each comprise one or more processors and one or more non-transitory computer readable media coupled to those processors. It should be understood that methods according to embodiments can conceivably be executed with other forms of multi-party computation networks 206, including multi-party computation networks comprising two computer systems or comprising more than three computer systems.

The computers of FIG. 2 may communicate with one another via a communication network, which can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between computers and devices may be transmitted using a secure communications protocol, such as, but not limited to, File Transfer Protocol (FTP); HyperText Transfer Protocol (HTTP); Secure HyperText Transfer Protocol (HTTPS); Secure Socket Layer (SSL), ISO (e.g., ISO 8583) and/or the like.

The first party computer 202 can correspond to a first party (e.g., a data owner) that possesses first party data that can be evaluated during a private parallel, multi-party graph analysis process. This first party data can comprise, e.g., first party financial transfer data, associated with financial transfers between individuals or businesses. The first party could comprise, for example, a first bank, and the financial transfer data could correspond to financial transfers between the bank's customers and other entities. As another example, the first party could comprise a first credit card company, and the financial transfer data could correspond to credit card purchases made by customers of the first credit card company. The second party computer 204 can likewise correspond to a second party possessing second party data, which may comprise second party financial transfer data. The second party can comprise, for example, a second bank, a second credit card company, etc.

The first party computer 202 and the second party computer 204 may construct a secret-shared union tuple list and secret-share this union tuple list among the members of the multi-party computation network 206, (i.e., the first server computer 208, the second server computer 210, and the third server computer 212), such that the multi-party computation network 206 receives the secret shared union tuple list. The union tuple list may be secret shared using any appropriate three party secret-sharing technique, such as the three party secret sharing technique of Araki [14], the secret-shared data may take the form of a secret-shared union tuple list, which may be constructed by the first party computer 202 and the second party computer 204 using a union garbled circuit protocol.

In brief, after receiving the secret-shared union tuple list, the computers in the multi-party computation network 206 can perform a multi-party computation on the secret-shared union tuple list. This multi-party computation can comprise, for example, a cycle detection computation or method. This computation can be performed by the first server computer 208, the second server computer 210, and the third server computer 212 using a three-party honest majority semi-honest multi-party implementation (e.g., as described in [14]) of a cycle detection method (or other appropriate graph analysis method, such as those described in Section F). If any cycles are detected in the secret-shared union tuple list, the multi-party computation network 206 can provide a notification of money laundering to the first party computer 202 and the second party computer 204.

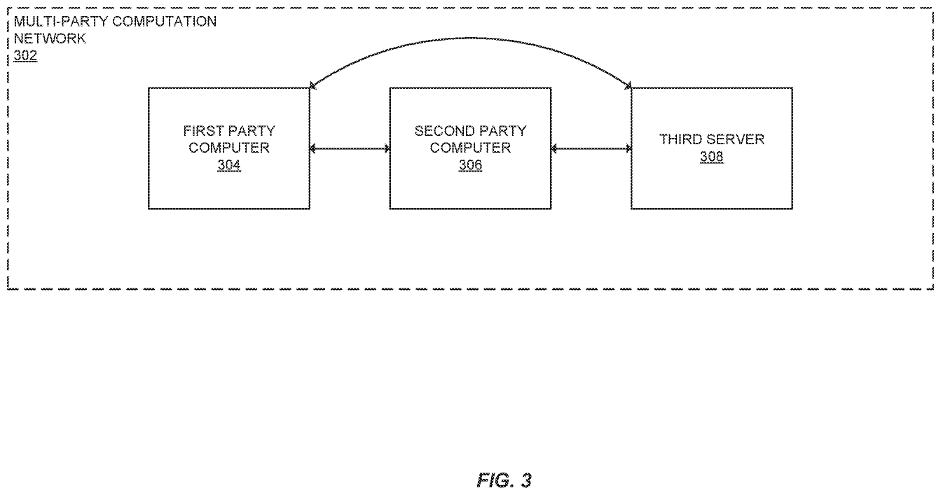

In some embodiments, the first party computer and second party computer may be members of the multi-party computation network, such that the first party computer is the first server computer and the second party computer is the second server computer. FIG. 3 shows an alternative system model according to these embodiments. In this system, the first party computer 304 and second party computer 306 can replace the first server computer and second server computer respectively. Further, in this system, the first party computer 304 and second party computer 306 may take a more active role in performing methods according to embodiments. These two computers can generate a secret-shared union tuple list based on their respective data, such that both the first party computer 304 and the second party computer 306 receive the secret-shared union tuple list. The first party computer 304, second party computer 306, and third server 308 can then perform a three-party honest majority semi-honest multi-party computation to produce a list of cycles in the union graph and/or a notification of money laundering activity.

Having introduced embodiments of the present disclosure, described the example graph, and introduced the system models, the rest of the detailed description is organized as follows: Section C describes some background concepts, including technical details that may facilitate a better understanding of the setup phase and computation phase, as well as some of the differences between embodiments and conventional graph analysis techniques. Section D describes the setup phase. Section E describes the computation phase. Section F describes some exemplary applications for embodiments, including privately determining a word frequency histogram, implementing a network ranking system, and implementing private matrix factorization. Section G describes some metrics and techniques that can be used to evaluate the performance of embodiments of the present disclosure. Section H describes a computer system according to some embodiments, and Section I provides a list of references.

### C. Background Concepts

Before describing some background concepts in more detail, a description of some notation may be useful in better understanding embodiments of the present disclosure. When referring to individual elements of a collection (e.g., a party of a plurality of parties, a tuple of a plurality of tuples), let i±1 refer to the next (+) or previous (−) with wrap around, e.g., party 3+1 refers to party 1, party 1−1 refers to party 3. Let K refer to the computational security parameter and λ refer to the statistical security parameter. Some embodiments of the present disclosure use κ=128 and λ=40 as the computational security parameters and statistical security parameter respectively.

### 1. Data Augmented Directed Graph

As described above, some embodiments of the present disclosure can be used to perform parallel private graph analysis using a multi-party computation network. Such graph analysis may be performed on a secret-shared union tuple list, which may represent a data augmented directed graph. As review, a directed graph G(V, E) can comprise a collection of vertices (or “nodes”) V that are connected by directed edges E, edges that point away from one connected vertex and point toward another connected vertex. A data-augmented directed graph G(V, E, D) consists of a directed graph G(V, E) comprising vertices V and edges E, as well as data corresponding to each vertex and each edge D∈({0,1})^{|V|+|E|}. For any given vertex v∈V and any edge e∈E, “v.data” and “e.data” may be used to refer to the data associated with that vertex and that edge respectively. For a data-augmented directed graph corresponding to financial transfer data, data associated with a vertex could comprise, for example, an identifier used to identify an individual or business associated with that vertex (e.g., a participant in a financial transfer). Likewise, data associated with an edge could comprise, for example, an amount (e.g., a dollar amount) associated with that financial transfer, a timestamp, a country of origin, or any other relevant information.

### 2. Representing Graph Data Using Tuple List

Multi-party computation networks according to embodiments can analyze graphs in tuple list form, which may be easier to operate on using linear scan operations. As described above, FIG. 1 shows a visual representation of a union tuple list 108 corresponding to union graph 106. In a tuple list, each graph element (vertex or edge) can be represented by a tuple, itself a list of elements, which can adhere to a tuple format such as (u, v, isVertex, isOriginal, data), in which u is a vertex, v is a connected vertex pointed at by a directed edge, isVertex is a bit designating whether the tuple corresponds to a vertex (where is Vertex=1 for vertex tuples and, is Vertex=0 for edge tuples), isOriginal is a bit designating whether an edge tuple is a duplicated edge tuple (1 for vertices, 1 for an original edge tuple, and 0 for a duplicate edge tuple), and data (sometimes represented as Dᵤ or D_{u, v}) is data associated with the particular graph element.

The use of duplicate edge tuples (such as duplicate edge tuple 110) is described in more detail below. Generally speaking, the use of duplicate edge tuples has the benefit of reducing the number of operations performed during the computation phase. Typically when using an SGA framework, there are three separate steps: a “Scatter” step, a “Gather” step, and an “Apply” step. However, by using duplicate edge tuples, it is possible to modify the SGA framework to combine the Scatter step and the Gather step, reducing the total number of steps (and therefore computations) that are performed. This has the benefit of increasing the speed and efficiency of graph analysis.

Returning to tuple format description, for a vertex tuple, u and v may both comprise the same value u, e.g., (u, u, 1, 1, Dᵤ). By comparison, an original edge tuple may comprise e.g., (u, v, 0, 1, D_{u,v}) and a duplicated edge tuple may comprise e.g., (u, v, 0, 0, D_{u,v}). Throughout the disclosure, vertex tuples may be referred to as “W-tuples” or “white” tuples, original edge tuples may be referred to as “G-tuples” or “gray” tuples, and duplicate edge tuples may be referred to as “Y-tuples” or “yellow” tuples. In the figures, vertex tuples are typically illustrated as rectangles with sharp corners, original edge tuples are typically illustrated as wide hexagons, and duplicate edge tuples are typically illustrated as rectangles with rounded corners. As with the graphs, for a secret-shared union tuple list comprising the union of two tuple lists (e.g., a first tuple list corresponding to a first party computer and a second tuple list corresponding to a second party computer), tuples corresponding to the first party are typically illustrated with solid edges, while tuples corresponding to the second party are typically illustrated with dashed edges.

### 3. Oblivious Functions and Memory Access

The term “oblivious” has different meaning in different cryptographic contexts. In a general sense, an action or function, performed on some data elements, is oblivious if that action or function does not reveal any information about those data elements. For example, in an oblivious sort, a party can sort a list of encrypted or secret shared data without revealing any information about that data (e.g., the relative “rank” or position of a particular data element). As another example, in an oblivious transfer, a receiving party can receive a message from a sending party, without the sending party knowing what message it sent. In general terms, oblivious “Scatter,” “Gather,” and “Apply” steps can mean that the Scatter, Gather, and Apply steps should not reveal any information about the secret-shared union tuple list which those steps are being performed on.

In embodiments of the present disclosure, a plurality of processors, or multiple pluralities of processors (e.g., each plurality of processors being associated with a different computer system in a multi-party computation network) may collectively and privately perform graph analysis, including the identification of cycles in a private union graph of financial transfer data. In order to perform this function, these processors may have to collectively access this secret-shared financial transfer data, represented by a secret-shared union tuple list. Such secret-shared financial transfer data may be stored in a shared memory, which may be either real or virtual. As an example, each processor may store some amount of secret-shared financial transfer data (e.g., in the form of secret-shared tuples) in local memory (e.g., RAM), but the processors may transmit or otherwise share this secret-shared financial transfer data with one another in order to perform multi-party computation functions. In such a case, the virtual memory array may comprise the collective local memory associated with the processors.

Generally, for multi-party computations involving shared memory arrays, it is often insufficient to simply perform multi-party computation using conventional techniques (e.g., garbled circuits or other MPC protocols) because accesses to the shared memory array (e.g., via read and write operations) may reveal information about the distribution of the data being operated on. For example, sorting operations may reveal the relative sorting rank of data elements (e.g., tuples) based on accesses to the shared memory. The use of oblivious functions is one technique that can be used to prevent such data leaks.

The following generally describes, in mathematical terms, such oblivious functions performed by multiple processors performing such functions in parallel. Consider N processors that make oblivious accesses to a shared memory array. Let a parallel method (e.g., a cycle detection method) execute in T parallel steps. Then, in every step, processors i∈[N] make access to some shared memory location add_{t,i}. The trace Tr(G) of the method is the ordered tuple that consists of all memory locations accessed by all processors:

Tr(G)=(addr_{t,i})_{t∈[T],i∈[N]}

A parallel graph processing method is oblivious, if for any input data-augmented graphs G=(V, E, D) and G′=(V′, E′, D′) with |V|+2|E|=|V′|+2|E′| and |d|=|d′| for d∈D and d′∈D:

Tr(G)=Tr(G′)

In some embodiments of the present disclosure, the parallel oblivious methods can be deterministic. In such cases, the traces for both graphs can be identical rather than identically distributed. Note that for any given graph G(V, E, D), some methods according to embodiments can reveal the total number of vertices and edges in the union graph, i.e., |V|+|E|.

### 4. Multi-Party Computation

Some details relating to multi-party computation techniques according to some embodiments are described below. Generally, once a secret-shared union tuple list has been generated, multi-party computation, performed by a multi-party computation network, can be used to perform graph analysis, such as determining a list of cycles in a union graph of financial transfer data.

Embodiments of the present disclosure can use a three-party honest majority semi-honest multi-party computation (MPC) protocol. This is in contrast to most conventional methods, which often use a two-party garbled circuit MPC protocol. The use of a three-party honest majority semi-honest MPC protocol enables the use of an efficient three-party honest majority, semi-honest oblivious shuffling protocol, which is an improvement over the conventional method of using oblivious sorting.

The differences between oblivious shuffling and oblivious sorting are described further below. In general terms, oblivious shuffling is less computationally intensive (and therefore faster and more efficient) than oblivious sorting. Further, there are efficient secret-sharing and three-party honest majority semi-honest oblivious shuffling protocols, which can be leveraged by embodiments to further improve performance.

In order to implement multi-party computation, some embodiments of the present disclosure can use the replicated secret sharing technique of Araki, et al. [14]. A secret value x∈ [symbol] ₂k can be shared by sampling three random values x₁, x₂, x₃ ∈ [symbol] ₂k such that x=x₁+x₂+x₃. These shares are distributed as pairs {(x₁, x₂), (x₂, x₃), (x₁, x₃)}, where each multi-party computation participant i (e.g., the first server computer 208, the second server computer 210, and the third server computer 212 from FIG. 2) holds the i^{th} pair. This secret sharing can also be denoted [symbol] x [symbol] ^{A}. This secret sharing protocol is resilient against one corruption, as any two of the three parties have sufficient information to reconstruct the value x. In embodiments of the present disclosure, three random values or vectors x₁, x₂, x₃ can be sampled that represent the secret-shared union tuple list. These values can be distributed among computers in a multi-party computation network, enabling the multi-party computation network to perform private parallel graph analysis.

Embodiments of the present disclosure can use multi-party computation software libraries in order to implement multi-party computation. These libraries can include the ABY³ library [11], which is implemented in C++ and provides support for replicated secret sharing. ABY³ uses the Boost C++ library for networking among parties. Additive secret sharing can be implemented on top of ABY³ to provide extra functionality. ABY³ can be used to implement three-party honest majority semi-honest secure multi-party computation. ABY³ uses the libOTe [12] library and provides C++ classes for composing circuit libraries. ABY³ additionally uses cryptoTools [13] which supports MPI-like non-blocking send and blocking receive operations. Processes in ABY³ are identified by their unique identifiers. Oblivious shuffling techniques such as those described in [2] can be implemented in ABY³.

### 5. Scatter-Gather-Apply (SGA)

Some embodiments follow the Pregel and GraphLab [4]-[6] programming paradigms. These programming paradigms are highly efficient for parallel computations performed on graphical data. In such paradigms, parallel graph processing methods can proceed in iterations. In each iteration, each vertex collects data from incoming edges (e.g., the directed edges that “point” to those vertices) and updates their values (i.e., the data D associated with those particular vertices) based on a function of this data and data associated with each vertex. These paradigms also referred to as “Scatter-Gather-Apply” (SGA), “Gather Scatter”, or other similar terms.

Scatter-Gather-Apply (SGA) is a data processing paradigm that can be applied to the design of graph-based methods. The idea, broadly, is that graph-based methods can be designed to comprise three steps: a Scatter step, a Gather step, and an Apply step. By repeatedly executing these three steps in sequence, a graph-based method, such as a cycle detection method, can be executed. One benefit of SGA techniques is that the steps are generally applied on a per-element (e.g., vertex, edge, etc.) basis, meaning that SGA methods can be made parallel. In each step, the graph elements can be divided among a pool of processors, and each processor can perform the step operations (e.g., Scatter step operations) on its assigned elements. For some SGA methods, if a sufficient number of processors are available, each processor could conceivably be assigned a single graph element, enabling highly parallel processing.

In a data-augmented directed graph (e.g., a graph where data can be associated with the vertices and or edges), the “Scatter” step generally involves each vertex broadcasting or “scattering” its data to connecting edges. The “Gather” step involves each vertex “gathering” or otherwise collecting the data on the connecting edges and aggregating that data with any existing data associated with that vertex. The “Apply” step involves applying a function to the data associated with each vertex. These steps can be repeated until an method (e.g., cycle detection) is complete. These steps are described in more detail below

### a) Scatter

The first step is known as the “Scatter step.” During this step, a vertex propagates data to its neighboring edges and updates the edge's data. More specifically, Scatter takes a user-defined function fₛ: {0,1}*→{0,1}*, and updates the data (e.data) associated with each directed edge e(u,v) in a manner consistent with the following pseudocode:

```
Scatter(G(V, E, D), ƒₛ, b)
For each e(u, v) in E
  If b = “in”
    e.data := ƒₛ(e.data, v.data)
  else
    e.data := ƒₛ(e.data, u.data)
```

In the above pseudocode, G(V, E, D) is the directed graph, fₛ is a scatter function, b is a control bit indicating the scattering direction (i.e., with or against the directed edges), e(u, v) is a directed edge pointing from vertex u to vertex v, e. data is the data associated with edge e(u, v), u.data is the data associated with vertex u, and v.data is the data associated with vertex v. In summary, if the control bit is set to “in,” each edge e(u, v) updates its data by applying the scatter function fs to its data and the data associated with vertex v (i.e., the vertex being pointed to by the directed edge). If the control bit is set to “out,” (or simply set to anything other than “in”), each edge e(u, v) updates its data by applying the scatter function fs to its data and the data associated with the vertex u (i.e., the vertex that is not being pointed to by the directed edge). Notably, the Scatter step is applied to each edge e(u,v) individually, meaning that edges (or representations of edges, such as tuples) can be divided among a pool of processors that can perform the Scatter step collectively in parallel.

The scatter function fₛ is typically user-defined and depends on the particular parallel private graph analysis method being implemented. As such, a different scatter function fₛ may be used for performing cycle detection than, for example, determining a minimum spanning tree or performing graph-based matrix factorization. In the Rocha-Thatte cycle detection method, described in further detail below, v.data and e.data may comprise lists of vertex identifiers, and the scatter function fₛ may comprise functional operations used to include the vertex identifiers from v.data into the list of vertex identifiers stored in e.data.

### b) Gather

The second step is known as the “Gather step” During the Gather step, each vertex aggregates data that it receives from incoming edges and stores the data locally. More specifically, Gather takes as input an binary aggregation operator ⊕: {0,1}*×{0,1}*→{0,1}* and updates the data (v.data) associated with each vertex v E V in a manner consistent with the following pseudocode:

```
Gather(G(V, E, D), ⊕, b)
for each v in V
  if b = “in”
    v.data = v.data ∥⊕_{∀e(u,v)∈E} e.data
  else
    v.data = v.data ∥⊕_{∀e(v,u)∈E} e.data
```

In this pseudocode, G(V, E, D) is the directed graph, ⊕ is an aggregation (or “gather”) function, b is a control bit indicating the gathering direction (i.e., with or against the directed edges), v is a vertex, V is the set of all vertices, v.data is the data associated with vertex v, e.data is the data associated with an edge e(u, v) (or e(v, u)) connected with vertex v and ∥ indicates the concatenation operation. In summary, if the control bit is set to “in,” each vertex v updates its data v.data by aggregating its data v.data and all data associated with incoming edges e(u, v) using the aggregation function ⊕. If the control bit is set to “out,” (or anything other than “in”), each vertex v updates its data v.data by aggregating its data v.data and all data associated with outgoing edges e(v, u) using the aggregation function ⊕. Notably the Gather step is applied to each vertex v individually, meaning that vertices (or representations of vertices, such as vertex tuples) can be divided among a pool of processors that can perform the Gather step collectively in parallel.

The aggregation function ⊕ is typically user-defined and depends on the particular parallel-private graph analysis method being implemented. As such, a different aggregation function ⊕ may be used for performing cycle detection than, for example, determining a minimum spanning tree or performing graph-based matrix factorization. In the Rocha-Thatte cycle detection method, described in further detail below, v.data and e.data may comprise lists of vertex identifiers, and the aggregation function ⊕ may comprise functional operations used to include the vertex identifiers in e.data into the list of vertex identifiers stored in v.data.

### c) Apply

The third step is known as the “Apply step.” During the apply step, vertices update their value using the data collected during the Gather step. Formally, the Apply step can involve performing a function f_{α}: {0,1}*→{0,1}* in a manner consistent with the following pseudocode:

Apply(G(V, E, D), ƒ_{A})
for each v in V
v.data := ƒₐ(v.data)

In this pseudocode, v.data is the data associated with a vertex v, V is the set of all vertices, and f_{A} is the apply function. In summary, during the Apply step, the apply function f_{A} is applied to the data associated with each vertex v. Notably, the Apply step is applied to each vertex individually, meaning that vertices (or representations of vertices, such as vertex tuples) can be divided among a pool of processors that can perform the Apply step collectively in parallel.

The apply function f_{A} is typically user-defined and depends on the particular method being implemented. As such, a different apply function f_{A} may be used for performing cycle detection, than, for example, determining a minimum spanning tree or performing graph-based matrix factorization. In the Rocha-Thatte cycle detection method, described in further below, v.data may comprise a list of vertex identifiers. The apply function f_{A} may comprise a function that checks if any list of vertex identifiers contains any repeat identifiers, or if a list of vertex identifiers corresponding to a particular vertex contains the identifier associated with that vertex. For example the list [2, 3, 4, 2] may be indicative of a cycle, or alternatively, vertex “2” possessing the list [2, 3, 4] may also be indicative of a cycle. Either of these cases may be an example of a “terminating condition.” If the Apply function detects a terminating condition, the apply function can terminate the SGA graph analysis method and output any relevant data (e.g., a list representing the cycle, such as [2, 3, 4].

Because the Apply step is only performed on vertices (as opposed to Scatter and Gather, which both involve vertices and edges), the Apply step risks leaking information about the structure of the graph, as a participant to the multi-party computation knows that if the Apply step is being performed on a data element (e.g., a tuple) that data element may correspond to a vertex. However, the Apply step can be made oblivious by performing a real Apply function f_{A} on each vertex tuple and a “dummy” Apply function on each edge tuple in the secret-shared union tuple list. In this way, an Apply function (real or dummy) is applied to each tuple in the secret-shared union tuple list, and consequently, the fact that an apply function is being performed communicates no information about the elements in the secret-shared union tuple list.

By properly defining the Scatter function fₛ, the Aggregation function ⊕, and the Apply function f_{A}, many graph-based methods, including the Rocha-Thatte cycle detection method, can be implemented according to the SGA paradigm, and consequently can be evaluated in a fast, parallel manner. In parallel private graph analysis, multi-party computation networks can perform the Scatter, Gather, and Apply steps in an iterative process, repeatedly performing these steps until the graph analysis method being implemented (e.g., cycle detection) is complete.

### 6. Combining Scatter and Gather Steps

As stated above, a multi-party computation network can perform the Scatter step, the Gather step, and the Apply step repeatedly until a particular graph analysis method (such as cycle detection) has been completed. Typically, if the graph is represented in some list form, the Scatter and Gather steps can be performed as individual linear scans on this list. This makes sense, conventionally, because the edges perform different functions in the Scatter and Gather steps (receiving data in Scatter and transmitting data in Gather). As such, it is conventionally logical to separate the Scatter step and the Gather step and perform the two steps as separate linear scans.

However, some embodiments make use of novel techniques to combine the Scatter step and the Gather step into a single Scatter-Gather step, which can be performed using a single, parallelized linear scan. In addition to reducing the total number of steps that need to be performed, this has the advantage of halving the number of oblivious sorting (or oblivious shuffling) operations that are performed (see the following subsection for more details on oblivious sorting and shuffling). Rather than performing oblivious sorting or oblivious shuffling prior to both the Scatter step and the Gather step, a multi-party computation network (such as the multi-party computation network of FIG. 2 or FIG. 3) only needs to perform oblivious sorting or oblivious shuffling prior to the Scatter-Gather step. This is particularly advantageous because these oblivious operations involve communications among processors which can be costly from a computational time perspective.

Generally, embodiments of the present disclosure can combine the Scatter step and Gather step by duplicating the edge tuples in the secret-shared union tuple list representing the union graph being processed. After this duplication, the list can comprise vertex tuples, “original edge tuples,” and “duplicate edge tuples.” In rough terms, during a linear scan of the secret-shared union tuple list, processors corresponding to the multi-party computation network can Scatter to one set of edge tuples (e.g., the original edge tuples) and Gather from the other set of edge tuples (e.g., the duplicate edge tuples), thereby enabling both the Scatter and Gather steps to be performed in a single linear scan.

In conventional SGA methods for a non-duplicated list, the non-duplicated list is first obliviously sorted, then a first linear scan is performed to propagate (i.e., scatter) data from the vertices to connected edges, completing the Scatter step. The non-duplicated list is obliviously sorted again, then a second linear scan is performed to gather data from in-going edges to the vertices, accomplishing the Gather step. Then a third linear scan is performed to apply a function to each vertex, completing the Apply step. This process is repeated iteratively until the SGA method is complete.

By contrast, in iterative SGA methods according to embodiments using duplicated edge tuples, the secret-shared union tuple list is obliviously shuffled, then a linear scan is use to propagate (i.e., scatter) data from the vertices to connected original edge tuples and at the same time gather data at the vertices from the duplicate edge tuples. Then a second linear scan is performed to apply a function to each vertex tuple. This process is repeated iteratively. On a subsequent iteration however, the duplicated list is obliviously shuffled, then a linear scan is used to propagate (i.e., scatter) data from the vertices to connected duplicate edge tuples and at the same time gather data at the vertices from original edge tuples. Afterwards a second linear scan is performed to apply a function to each vertex tuple. The process continues iteratively until the SGA method has been completed, swapping the role of original edge tuples and duplicate edge tuples with each iteration.

This technique effectively enables both a scatter step and a gather step to be performed in a single linear scan. On any round of this modified iterative SGA method, data can be scattered to a first set of edge tuples (e.g., the original edge tuples) and gathered from a second set of edge tuples (e.g., the duplicate edge tuples), effectively reducing the total number of linear scans that need to be performed from three (one for Scatter, Gather, and Apply) to two (one for Scatter-Gather, and one for Apply).

### 7. Sorting Versus Shuffling

In some conventional techniques for SGA-based graph analysis, an oblivious sorting operation is performed at the beginning of the Scatter step and at the beginning of the Gather step. This oblivious sorting operation facilitates processing the graph using a linear scan. A linear scan, generally involves processing some collection of elements (e.g., graph elements such as vertices and edges) sequentially, typically operating on the collection of elements represented in a list form. As described above, the Scatter step involves taking data from vertices and “scattering” that data to the directed edges connected to those vertices. As such, when performing the Scatter step using linear scan operations, it is convenient to have the directed edges follow their respective vertices in the representational list. The Gather step involves taking data from directed edges and “gathering” that data into the vertices pointed to by those edges. As such, when performing the Gather step using linear scan operations, it is convenient to have the directed edges precede their respective vertices in the representational list. Hence, it is can be advantageous to obliviously sort the list (such that the vertices precede the edges) prior to the Scatter step and obliviously sort the list (such that the edges precede the vertices) prior to the Gather step.

However, these sorting operations, performed in conventional techniques, are largely redundant. The SGA steps, as well as the sorting operation do not change the overall structure of the graph being processed. This means that after Scatter sorting operation, the list will be in the same order, regardless of the number of sorting operations that have been performed. Likewise, after each Gather sorting operation, the list will be in the same order, regardless of the number of sorting operations that have been performed. As a consequence, it is only necessary to sort the graph elements twice, in order to determine the necessary orderings (i.e., the Scatter ordering and the Gather ordering) and some representations, such as permutations, that can be used to put the graph elements in those orderings without sorting.

As described above, embodiments of the present disclosure combine the Scatter and Gather steps by using an alternate tuple list representation involving duplicate edge tuples. However, the oblivious sorting principles above still generally apply. During the setup phase, the multi-party computation network can obliviously sort the secret-shared union tuple list into a first ordering, and determine a first permutation corresponding to the first ordering. This first permutation can be cached or otherwise stored for later use. This first permutation can be used to put the secret-shared union tuple list into the first ordering using an oblivious shuffling operation (not an oblivious sorting operation) during the computation phase. Oblivious shuffling operations are often faster than oblivious sorting operations. Likewise, during the setup phase, the multi-party computation network can obliviously sort the secret-shared union tuple list into a second ordering and determine a second permutation corresponding to the second ordering. The second permutation can be cached or otherwise stored for later use. The second permutation can be used to put the secret-shared union tuple list into the second ordering using an oblivious shuffling operation (not an oblivious sorting operation) during the computation phase.

When executing an SGA parallel private graph analysis method during the computation phase, the multi-party computation network can obliviously shuffle (not sort) the secret-shared union tuple list into the first ordering prior to the combined Scatter-Gather step. After performing the combined Scatter-Gather step and the Apply step, the multi-party computation network can obliviously shuffle the secret-shared union tuple list into the second ordering using the second permutation. This process can be repeated until the SGA parallel private graph analysis method has been completed, resulting in, e.g., a list of one or more cycles in the union graph represented by the secret-shared union tuple list.

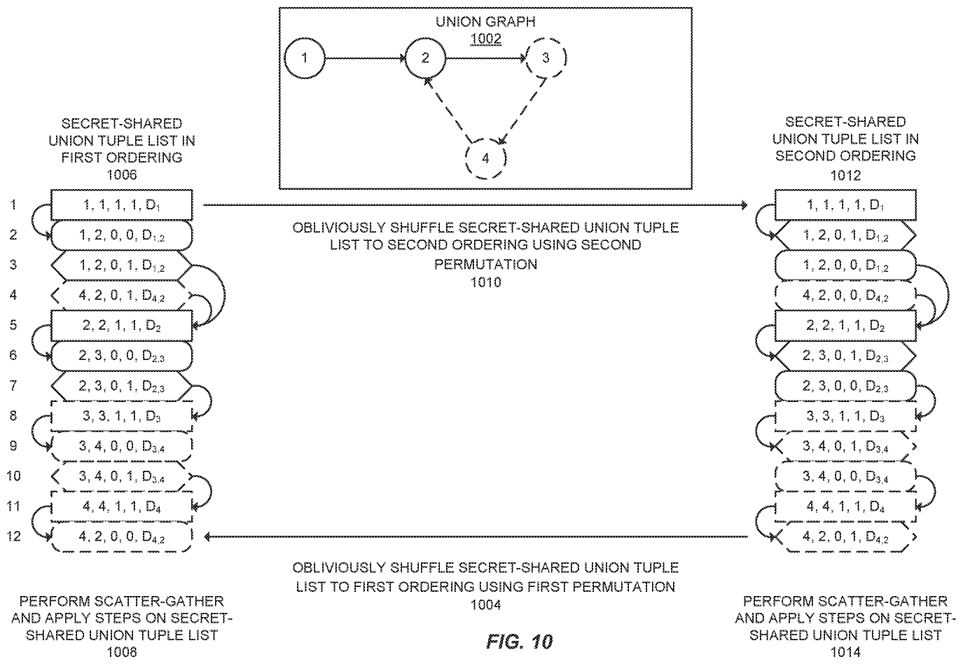

In more detail, in the first ordering, each vertex tuple can be preceded by relevant original edge tuples (e.g., edge tuples corresponding to directed edges that point toward that vertex tuple) and followed by relevant duplicate edge tuples (e.g., edge tuples corresponding to duplicated directed edges that point away from that vertex). Using the “W, G, Y” tuple notation described above, a string representation of the first ordering is: (G*WY*)*, where * is the Kleene operator. This means, broadly, that the list can take the form of any number of original edge tuples (including zero) followed by a vertex tuple, followed by any number of duplicate edge tuples, and this pattern can be repeated any number of times. As an example, the secret-shared union tuple list in the first ordering 1006 in FIG. 10 can be represented as the string WYGGWYGWYGWY. In the first ordering, during the Scatter-Gather step, the multi-party computation network can Scatter from the vertex tuples to the duplicate edge tuples, and Gather from the original edge tuples to the vertex tuples.

In more detail, in the second ordering, each vertex tuples can be followed by relevant duplicate edge tuples (e.g., duplicate edge tuples corresponding to directed edges that point toward that vertex tuple) and preceded by relevant original edge tuples (e.g., original edge tuples corresponding to directed edges that point away from that vertex tuple). Using the “W, G, Y” tuple notation describe above, a string representation of the second ordering is (Y*WG*)*. This means, broadly that the secret-shared union tuple list can take the form of any number of duplicate edge tuples (including zero) followed by a vertex tuple, followed by any number of original edge tuples, and this pattern can be repeated any number of times. As an example, the secret shared union tuple list in the second ordering 1012 in FIG. 10 can be represented as the string WGYYWGYWGYWG.

As stated above, the multi-party computation network can obliviously shuffle the secret-shared union tuple list between the first ordering and the second ordering, using the determined permutations, during or prior to each combined Scatter-Gather step. Notably, embodiments perform half as many oblivious shuffling operations (one oblivious shuffling operation per Scatter-Gather step) as conventional methods perform oblivious sorting operations (one oblivious sorting operation per Scatter step and one oblivious sorting operation per Gather step). This leads to an improvement in speed and efficiency for two reasons. The first is that performing less operations naturally reduces execution time. The second is that oblivious shuffling operations have lower time complexity than oblivious sorting operations, and thus substituting oblivious shuffling for oblivious sorting further reduces execution time.

### a) Edge Prefix Definitions

Having described the first ordering and second ordering in some detail, some tuple prefix and suffix definitions may be useful in better understanding embodiments of the present disclosure.

Definition 1 (Longest Edge Prefix). For a tuple j∈{1, 2, . . . , N}, the longest edge prefix before j, denoted LEP[1, j], is defined to be the longest consecutive sequence of G-tuples before j, not including j. Note that when the j^{th} tuple is a Y-tuple, LEP can be empty because the prefix of a Y-tuple often starts with either a Y-tuple or a W-tuple.

Definition 2 (Longest Edge Suffix). For a tuple j∈{1, 2, . . . , N}, the longest edge suffix after j, denoted LES[1, j], is defined to be the longest consecutive sequence of Y-tuples after j, not including j. Note that when the j^{th} tuple is a G-tuple, LES can be empty because the suffix of a G-tuple often starts with either a G-tuple or a W-tuple.

Let 1≤i≤j≤N, the notation LEP[i, j] is used to denote the longest consecutive sequence of G-tuples before tuple j, constrained to the subarray G[i, . . . , j) (where the index i is inclusive, and index j is exclusive). Similarly, the notation LEP (j, k] is used to denote the longest sequence of Y-tuples after j constrained to the subarray G[j, k) (where the index j is exclusive, and index k is inclusive).

Definition 3 (Longest Prefix Sum). Let 1≤i≤j≤N, the notation LPS[i, j) is used to denote the aggregation (with respect to the ⊕ operator) of LEP[i, j).

Definition 4 (Longest Suffix Distributed). Let 1≤i≤j≤N, the notation LSD[i, j) is used to denote the process of writing a value v among the tuples of LES[i, j).

Abusing notation, LPS[i, j) can be treated as an alias for LPS[1, j) if j<1. Similarly, LSD(j, k] can be treated as an alias for LSD(j, N] if k>N.

### b) Shuffling Specifics

As described above, each iteration of the combined Scatter-Gather step can begin with an oblivious shuffling process. This section describes oblivious shuffling techniques, such as the shuffling method described by Chida et al [2] in more detail. The shuffling method of [2] involves steps in which parties apply permutations to a list that comprises secret-shared elements (e.g., secret-shared tuples). Furthermore, the shuffling method additional involves steps in which the computers in the multi-party computation network can reveal permuted secret shares to each other. Let P be the number of processors associated with each computer in the multi-party computation network. Let G be the corresponding secret-shared list. If the elements of the secret-shared list are divided evenly among the P processors, each of the P processors can be responsible for computing a permutation of G/P tuples in the secret-shared tuple list.

Briefly, the oblivious shuffling process can function as follows. Inputs can comprise secret shares of a key and a value. Without loss of generality, assume that each item consists of a single key and a single value. Let [symbol] be the bit length of the keys. Let k̅ and v̅ be the set of keys and associated values that are to be sorted.

Some sorting protocols implement a stable sort, in which the order of elements are rearranged based on the keys. A relative order is maintained for items with equal keys. In other words, the protocol outputs v̅′=(v₁, v₂, . . . , vₙ) that satisfies the following conditions. Let σ be the permutation that satisfies v̅′=σv̅, and k̅′=σk̅. It hold that kᵢ≤kᵢ₊₁, and if kᵢ=kⱼ, then σ⁻¹(i)<σ⁻¹(j) only when i<j.

The sorting protocol of Chida et al. [2] implements a variant of radix sort by combining a sequence of [symbol] permutations. Each of these permutations is a re-arrangement of the keys based on a specific bit of the key. Note that if all these permutations are applied one after another, then the resulting order of the keys will be the sorted order. However, the construction of Chida et al., do not apply these permutations directly. Instead, it computes the composition of the permutation and then applies the composed permutations all at once. By doing so [2] improves the total communication cost of the sorting protocol compared to the construction of [7] which applies the permutation for every bit. Embodiments of the present disclosure can adopt the approach by Chida [2] et al., first composing permutations corresponding to all the bits and then apply these permutations only once at the end.

These methods generate the abovementioned permutations in a preserving manner. Each of these protocols adopts an approach due to Bogdanov et al. [7] which takes in an secret share comprising the i^{th} bit of the key and generates a permutation σ whose inverse sorts the key as per the i^{th} bit. Some embodiments repeatedly compute these permutations for each bit of the key.

### 8. Garbled Circuits

Several steps in methods according to embodiments, including privately determining the union of tuple lists can be implemented using garbled circuits. Garbled circuits are a known concept within the field of cryptography. This summary of garbled circuits is intended primarily to facilitate a better understanding of embodiments of the present disclosure.

A garbled circuit can comprise a cryptographic protocol that enables two-party (or more) secure computation. Two parties can use a garbled circuit to evaluate a function on their private inputs. For example, a first party and a second party, possessing a first set and a second set, can use a garbled circuit to determine the intersection of their two sets, without requiring either party to reveal their set to the other party. Such an application of garbled circuit can be referred to as “circuit-PSI.”

A garbled circuit is so-called because the function being evaluated can be described as a Boolean circuit. This Boolean circuit can then be “garbled,” enabling it to be evaluated in encrypted form. This garbling mechanism is what enables the function to be evaluated without either party revealing their (encrypted) private inputs to one another.

A Boolean circuit generally comprises a collection of Boolean gates connected by wires. Often, in cryptographic contexts, Boolean circuits are models, and thus the wires and gates do not exist as physical objects. Typically, a Boolean circuit is evaluated by processors or other computer systems in order to determine the output of the Boolean circuit based on its inputs.

A Boolean gate typically comprises one or more inputs and an output. “Signals,” comprising the Boolean values {0, 1} (or {FALSE, TRUE}), are carried by the wires to the inputs of the Boolean gate. The Boolean gate produces an output (also a Boolean value), which is carried by a wire through the rest of the circuit. As an example, a two input Boolean “AND” gate produces a Boolean value of 1 if both of its inputs are 1, and produces a Boolean value of 0 otherwise. The relationship of the inputs and outputs for a Boolean gate can be defined by “truth table,” a table that relates every combination of Boolean valued inputs with their respective Boolean output.

Wires and Boolean gates can be combined to produce a wide variety of Boolean circuits implementing useful functions. For example, addition can be implemented using a ripple-carry adder circuit. Multiplication can be implemented using a Wallace tree or a Dadda multiplier. Comparatively complex functions such as determining the set intersection or outputting cycles in a graph can also be implemented using Boolean circuits.

### a) Garbled Circuit Generation

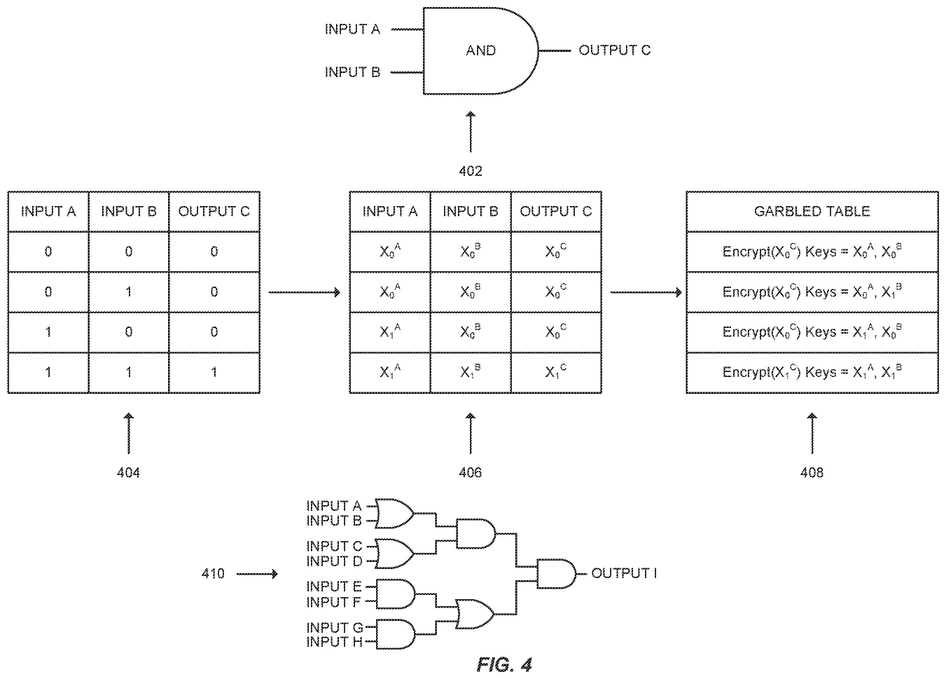

In broad terms, a Boolean circuit is “garbled” by replacing each value associated with each truth table corresponding to each gate in the Boolean circuit with randomly generated “labels,” then using the input labels to encrypt the output label. The process used to generate a garbled gate is summarized in FIG. 4. FIG. 4 shows an AND gate 402, comprising two inputs: input A and input B, along with an output C. The truth table 404 for this AND gate is shown.

A “garbler” (e.g., one of the two parties) can replace each Boolean value in the truth table 404 with a randomly generated label, producing a labeled table 406. In labeled table 406, the label associated with a Boolean value of 0 for input A is “X₀^{A},” and the label associated with a Boolean value of 1 for input A is “X₁^{A}”. A similar labelling scheme is used for the labels for input B and output C.

The garbler can then encrypt each output label using a known cryptosystem and the two corresponding input labels as cryptographic keys. For example, the label X₁^{C} can be encrypted using labels X₁^{A} and X₁^{B}. This process can be repeated for every row in the table, resulting in a garbled table 408. Although not shown in FIG. 4, the rows of the garbled table may be shuffled or otherwise randomized, in order to prevent an observer from determining any correspondence between labels and their associated values based on the row order.

To evaluate the garbled gate, an “evaluator” (e.g., the other of the two parties) can attempt to decrypt each row in the table using the labels corresponding to their respective inputs. For example, if the evaluator's inputs correspond to A=0, and B=1, the evaluator can attempt to decrypt each row in the garbled table 408 using the input labels X₀^{A} and X₁^{B}. Because only one of these rows corresponds to an output label encrypted with those input labels, the evaluator will (generally) only succeed at decrypting that respective row and receiving the corresponding output label (X₀^{C}).

For a garbled circuit comprising multiple gates (e.g., circuit 410), this process could be performed for each gate sequentially, eventually resulting in a set of labels corresponding to the output of the function evaluated by the garbled circuit. The garbler can then convert these labels back into their respective Boolean values, which can be interpreted as the output of the function. As an example, for a garbled circuit that determines a private set intersection, these Boolean values could correspond to the intersection set of the two input sets.

### b) Garbled Circuit Unionization

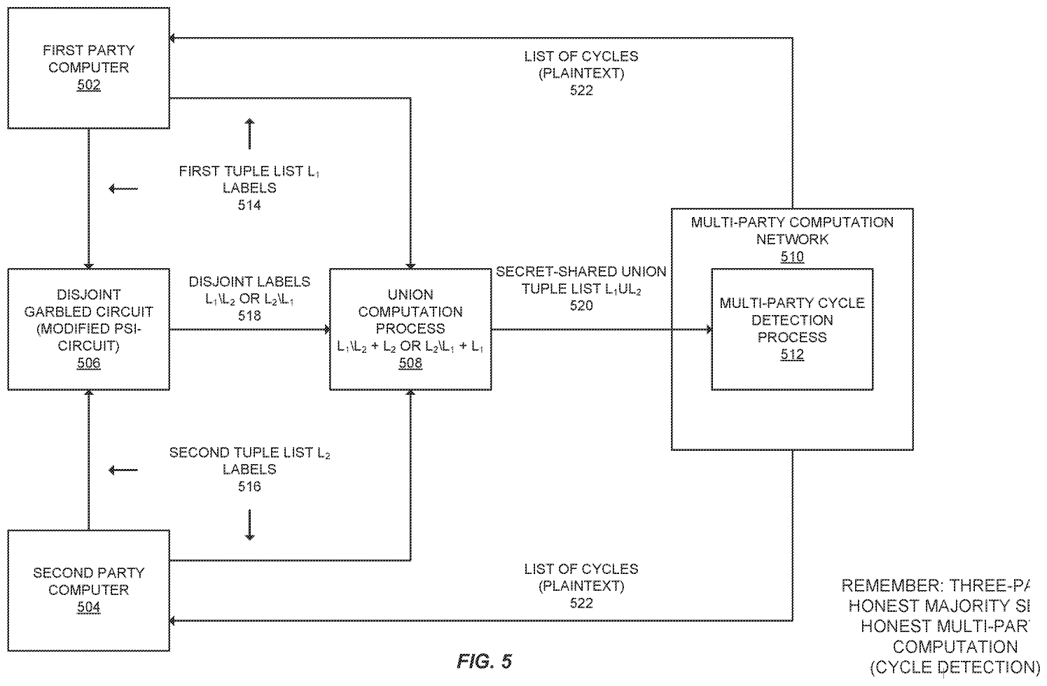

FIG. 5 illustrates how a first party computer 502 and a second party computer 504 can use garbled circuits to generate a secret-shared union tuple list 520. This secret-shared union tuple list can be provided to a multi-party computation network 510, which can evaluate the secret shared union tuple list using multi-party cycle detection process 512 in order to return a list of cycles 522 to the first party computer 502 and the second party computer 504. These cycles can comprise, for example, evidence of money laundering activity.

The first party computer 502 and second party computer 504 can use a disjoint garbled circuit 506, as well as a union computation process 508 to generate the secret-shared union tuple list 520. The combination of the disjoint garbled circuit 506 and the union computation process may be referred to collectively as a private union garbled circuit protocol. In FIG. 5, it is assumed that the garbled circuit has been previously generated (e.g., by one of the parties acting as a garbler or by a trusted third party).

The first party computer 502 and the second party computer 504 can each represent their respective financial transfer data as a list of tuples, i.e., a first party tuple list and a second party tuple list. Each party can then use their respective tuple lists to generate a list of labels which can be used as inputs to the disjoint garbled circuit 506, i.e., first party tuple list labels 514 and second party tuple list labels 516. These labels can be used as the input to a disjoint garbled circuit 506 that is used to determine the disjoint of their respective lists (e.g., all the labels corresponding to the first tuple list that are not contained in the second tuple list, or all the labels corresponding to the second tuple list that are not contained in the first tuple list. This disjoint garbled circuit 506 can comprise a modified private set intersection (PSI) garbled circuit protocol, which can be configured to produce a plurality of secret shared disjoint tuples (or labels) 518 based on the first party tuple list labels 514 and the second party tuple list labels 516.

The specific configuration of such a garbled circuit (e.g., the number and organization of gates) are not described herein. Generally, such garbled circuits require a large number of gates (e.g., on the order of tens or hundreds of thousands) which make them difficult to illustrate and describe with figures. Summarily, conventional circuit-PSI protocols involve collecting all the labels corresponding to the input sets (e.g., the first party tuple list labels 514 and the second party tuple list labels 516) then using a garbled circuit to only reveal the labels that are present in both input sets, thereby determining the intersection of the two sets. A conventional circuit-PSI protocol can be modified to reveal the labels that are present in one input set (e.g., the first party tuple list labels 514) and are not present in the other (e.g., the second party tuple list labels 516). In this way, the modified circuit-PSI protocol can be used to produce a disjoint garbled circuit 506, which can produce the disjoint of the first party tuple list labels 514 and the second party tuple list labels 516. These disjoint labels 518 (i.e., either L₁\L₂ or L₂\L₁) can be used to compute the secret-shared union tuple list 520, as described below.

The disjoint labels 518, as well as the first party tuple list labels 514 or the second party tuple list labels 516 can be used as the input to a union computation process 508. The union computation process 508 can generate the union L₁ U L₂ using either the formula L₁ U L₂=L₁\L₂+L₂ or L₁ U L₂=L₂\L₁+L₁ depending on how the disjoint labels 518 were generated. As such, the union computation process 508 can combine the plurality of secret-shared disjoint tuples (or disjoint labels 518) with either the first party tuple list labels 514 or the second party tuple list labels 516 to generate the secret-shared union tuple list 520 i.e., L₁ U L₂ 520.

In some embodiments, because the label sets L₁\L₂ and L₂ or L₂\L₁ and L₁ are disjoint (i.e., do not contain any common elements), the union computation process 508 can comprise a concatenation operation, e.g., by concatenating a label list corresponding to L₁\L₂ and the second party tuple list labels L₂ 516, or by concatenating a label list corresponding to L₂\L₁ and the first party tuple list labels L₁ 514.

The secret-shared union tuple list L₁ U L₂ 520 can be secret-shared among computers or devices in a multi-party computation network 510 (e.g., multi-party computation network 206 from FIG. 2), which can use the secret-shared union tuple list 520 to perform a multi-party cycle detection process 512. This multi-party cycle detection process 512 can comprise, for example, a three-party honest majority semi-honest computation using the techniques described in [14], and can involve an SGA implementation of the Rocha-Thatte method (described further below) in order to produce a plaintext list of cycles 522. This plaintext list of cycles 522 can be returned by the multi-party computation network to the first party computer 502 and the second party computer 504.

It should be understood that the description of the system of FIG. 5 is intended as an example and is not intended to be limiting. There are a number of apparent variations on this system. For example, the union computation process 508 could be implemented using a garbled circuit, and the disjoint garbled circuit 506 and the union computation process 508 could then be implemented as a single garbled circuit system. As another example, the multi-party computation network 510 could evaluate the disjoint garbled circuit 506 and execute the union computation process 508 rather than the first party computer 502 and the second party computer 504 evaluating and executing these processes. FIG. 5 implicitly assumes a system model similar to the system model depicted in FIG. 2 (as opposed to the model depicted in FIG. 3), although either model is valid.

### 9. Rocha-Thatte Cycle Detection

As described above, some embodiments are directed to efficient parallel private cycle detection techniques, used to detect cycles in union graphs representing financial transfer data, for the purpose of detecting money laundering or evidence thereof. To this end, embodiments can use any appropriate cycle detection method or technique. However, some embodiments can specifically use the Rocha-Thatte (RT) method [3]. In such embodiments, a multi-party computation network can perform a private multi-party Scatter-Gather-Apply implementation of a Rocha-Thatte cycle detection method in order to detect one or more cycles in a secret-shared union tuple list.

The RT method is a parallel cycle detection method that is well suited to the SGA framework because the RT method is round based, and individual operations in the RT method are similar to individual SGA operations (i.e., Scatter, Gather, and Apply). However, it should be understood that embodiments of the present disclosure can be practiced with any acceptable cycle detection method. Another cycle detection method that can be used is a parallel implementation of Dijkstra's method.

The RT method is summarized at a high level in the table below. The inputs of the RT method are a directed graph G(V, E) and a maximum cycle length [symbol] *. The RT method outputs a list of all cycles in the directed graph G(V, E) that have length less than or equal to the maximum cycle length [symbol] *.

Rocha-Thatte method for cycle detection

// [symbol] * is the maximum length of the cycle
1: input: G(V, E), [symbol] *
2: output: list of all simple cycles in G
3: for [symbol] = 1, 2, 3, ... , [symbol] * do

In summary, in the RT method, each vertex in a graph has an assigned identifier and is initially labelled as an “active vertex.” In each iterative round of the method, each vertex can broadcast its identifier, along with each identifier received from the previous round. These identifiers are broadcasted along the directed edges of the graph. If a vertex receives its own identifier in a broadcast, that vertex can conclude that the graph contains a cycle, as the identifier has been broadcast through the graph and returned to its starting position. Under certain conditions, a vertex will become inactive and cease broadcasting. This can occur for example, if a vertex receives no vertex identifiers from other vertices, and therefore cannot be a part of a cycle. Once all vertices have become inactive (which may be referred to as a “halting condition”), each vertex that has detected a cycle can output that cycle, e.g., as an ordered list such as [2,3,4]. In some implementations, multiple vertices can detect cycles simultaneously. In these cases, there may be some control logic in place that prevents multiple vertices from outputting the same cycle. As an example, if multiple vertices detect the same cycle, the vertex with the least identifier or the greatest identifier could output the cycle.

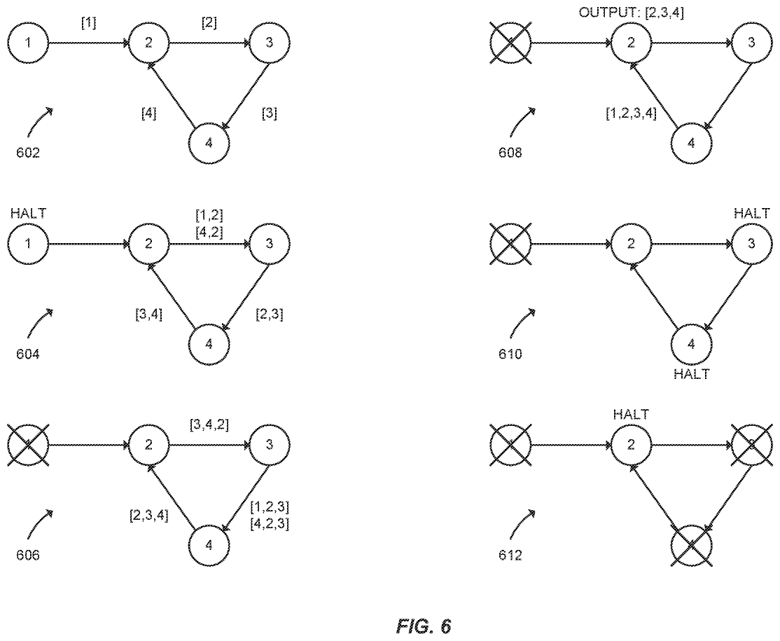

An exemplary execution of Rocha-Thatte is described with reference to FIG. 6, which was adapted from the Rocha-Thatte paper. FIG. 6 shows the exemplary directed graph of FIG. 1 comprising four vertices: 1-4. In FIG. 6, lists of vertex identifiers are represented by brackets. For example [4] represents a list comprising one vertex identifier corresponding to Vertex 4, and [1, 4] represents a list comprising two vertex identifiers corresponding to Vertices 1 and 4.

At round 602, each vertex broadcasts its respective identifier along the directed edges. As such, Vertex 1 receives no broadcast, Vertex 2 receives [1] and [4]. Vertex 3 receives [2], and Vertex 4 receives [3].

At round 604, each vertex broadcasts identifiers along the directed edges based on the identifiers received in the previous round. Vertex 1, having received no broadcasts, concludes that it is not part of a cycle and halts participation in the cycle detection method. Vertex 2, having received [1] and [4], broadcasts [1,2] and [4,2] along its outgoing edge. Vertex 3, having received [2], broadcasts [2,3] along its outgoing edges. Vertex 4, having received [3], broadcasts [3,4] along its outgoing edge.

At round 606, each vertex broadcasts identifiers along the directed edges based on the identifiers received in the previous round. Vertex 1 does not participate, having halted in round 604. Vertex 2, having received [3,4] in round 604, broadcasts [3,4,2] along its outgoing edge. Vertex 3, having received [1,2] and [4,2], broadcasts [1,2,3] and [4,2,3] along its outgoing edges. Vertex 4, having received [2,3], broadcasts [2,3,4] along its outgoing edge.

At round 608, Vertices 2, 3, 4 may each simultaneously determine that a cycle exists in the graph, as each of these vertices received a broadcast containing its own identifier in round 606. To prevent multiple reporting, the vertex with the lowest identifier (Vertex 2) can output the cycle, while the other two vertices output nothing. Each of these vertices may stop broadcasting identifiers corresponding to the cycle. As such, neither Vertices 2 or 3 may broadcast. Vertex 4 however, received two broadcasts [1,2,3] and [4,2,3] in the previous round. Because [1,2,3] may be part of a larger cycle, Vertex 4 may continue this broadcast chain, and broadcasts [1,2,3,4] along its outgoing edge.

At round 610, because Vertices 3 and 4 receive no broadcasts in the previous round, they may conclude that they are not part of any more cycles and can halt participation in the cycle detection method. Vertex 2 received broadcast [1,2,3,4] in the previous round, which it can conclude contains the previously detected loop [2,3,4]. As such, Vertex 2 may not continue this broadcast chain.

At round 612, having received no broadcasts in the previous round, Vertex 2 may conclude that there are no more cycles involving Vertex 2 and may halt participation in the cycle detection method. At this point, no vertices are participating in the cycle detection method, and the RT method has been completed. Vertex 2 can output the detected cycle at this time, if it did not do so in an earlier round (e.g., round 608).

As stated above, some embodiments of the present disclosure can use a private SGA implementation of the RT method in order to detect cycles, particularly in private financial transfer graphs for the purpose of detecting money laundering activities. In general terms, vertex identifier broadcasting in the RT method can be implemented using the Scatter function, compiling vertex identifiers into broadcast lists can be implemented using the Gather (or aggregation) function, and detecting cycles or determining whether to halt participation can be implemented using the Apply function. Implementing RT using SGA enables the RT method to be executed in a parallel manner, decreasing the time it takes to detect a cycle, increasing the speed and efficiency of graph processing.

In some embodiments of the present disclosure, the Rocha-Thatte cycle detection method can be modified in order to improve the speed and efficiency of cycle detection. In some embodiments, the Rocha-Thatte cycle detection method can be modified to assign a plurality of scatter probabilities to a plurality of secret-shared union edge tuples in the secret-shared union tuple list. Vertices can scatter to those edges based on these scatter probabilities, e.g., if a certain edge has probability 90%, there is a 90% chance that a connected vertex will scatter to that edge. This probability can be set statically, prior to the first round of the RT method, or be set dynamically during the execution of the RT method. For example, if a vertex receives a comparatively large number of broadcasts from its ingoing edges, the probability of scattering on its outgoing edges may increase. As another example, if a vertex receives a comparatively small number of broadcasts from its ingoing edges, the probability of scattering to its outgoing edges may decrease. Applying a probability to each edge may reduce the probability of detecting a particular cycle, but may also reduce the amount of time needed to execute the method.

In some embodiments, the Rocha-Thatte cycle detection method can be modified to restrict a maximum size of cycle detection messages (e.g., the broadcasts described above) to a predetermined value, otherwise referred to as a constant C. This has at least two benefits. The first is that it enables early termination of the method (i.e., once the broadcast messages exceed C), reducing the total execution time and increasing speed and efficiency. This event, i.e., when cycle detection messages exceed the predetermined value may comprise a “terminating condition.” The second benefit is related to cycle detection in transaction graphs. Often money laundering is evidenced by relatively short cycles in transaction graphs, e.g., cycles of length 4-8. Longer cycles can exist in legitimate commerce. For example, a rare-earth metal mining company may purchase products (e.g., computer-controlled excavation equipment) that are produced using the minerals mined by the company. This phenomena is both cyclical and not indicative of money laundering. Thus limiting the message length of cycles may prevent the detection of money-laundering false positives.

### D. Setup Phase

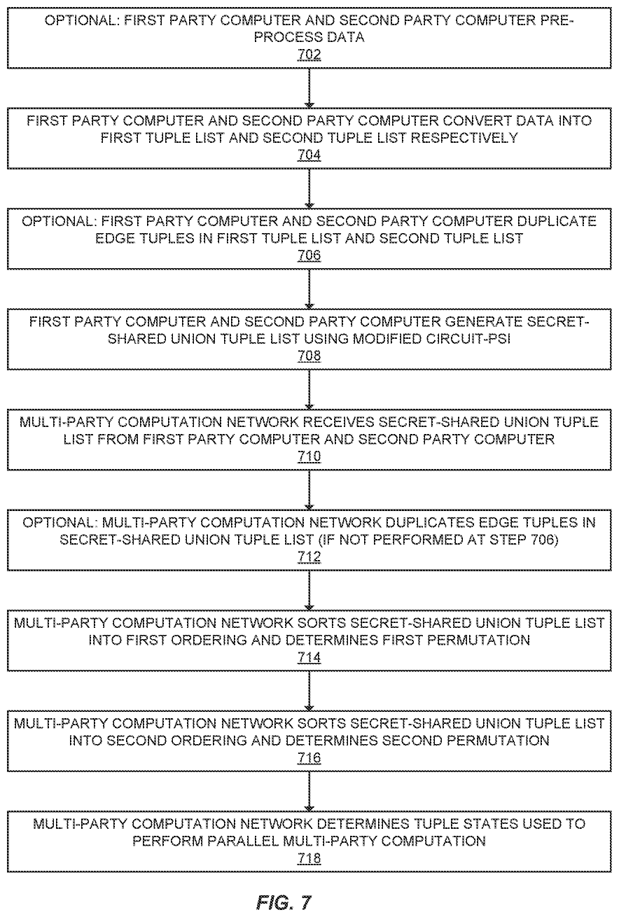

Having described some of these background concepts in detail, it may be appropriate to describe the setup phase. The setup phase broadly comprises the steps performed prior to performing parallel private graph analysis on a secret-shared union tuple list. The setup phase can comprise generating the secret-shared union tuple list, as well as obliviously sorting the secret-shared union tuple list in order to generate a first permutation and a second permutation, which can be used during the computation phase to obliviously shuffle the secret-shared union tuple list between a first ordering and a second ordering, as described above. The setup phase is described with reference to FIGS. 7-9.

### 1. Pre-Union Processing

Pre-union processing generally refers to steps in the setup phase that can be performed by the first party computer and the second party computer prior to generating the secret-shared union tuple list (as described in Section C above). The step of pre-union processing is described with reference to steps 702-706 in FIG. 7.

At step 702 the first party computer and second party computer can pre-process their respective data used to generate the secret-shared union tuple list. This data can comprise, for example, financial transfer data. The first party computer and second party computer can remove any irrelevant information from this data, such as information that is not needed as part of cycle detection. This could include, for example, personally identifying information corresponding to individual's financial transfer data. Removing this irrelevant information can decrease the size of the first party data and second party data, decreasing the communication cost associated with generating the secret-shared union tuple list.

Additionally, the first party computer and second party computer can pre-process their respective data by removing any data elements (e.g., tuples) corresponding to vertices with zero in-degree or zero out-degree (e.g., vertices with no incoming directed edges and/or vertices with no outgoing directed edges). Such vertices cannot be part of cycles, and therefore do not need to be analyzed in a multi-party cycle detection process. Further, the first party computer and second party computer can optionally pre-process their data by locally detecting any local cycles in their respective data. Each party can detect local cycles without needing to perform secure multi-party computation, and hence such cycles can be detected prior to generating the secret-shared union tuple list.

At step 704, the first party computer and second party computer can convert their respective data (e.g., first party financial transfer data and second party financial transfer data) into a first tuple list and second tuple list respectively. The first tuple list and second tuple list can be combined in a tuple list unionization process (described further below) to generate the secret-shared union tuple list. The first party computer and second party computer can use any appropriate data processing technique in order to generate the first party tuple list and second party tuple list.

At optional step 706, the first party computer and second party computer can duplicate edge tuples in the first tuple list and second tuple list. As described above, the duplicate edge tuples can be used in order to combine the Scatter and Gather steps of an SGA parallel private graph analysis method into a single Scatter-Gather step. The edge tuples can also be duplicated after the secret-shared union tuple list is generated (e.g., at step 708), hence step 706 is optional.

### 2. Tuple List Unionization

At step 708, the first party computer and second party computer can generate the secret-shared union tuple list using a private union garbled circuit protocol, such as the private union garbled circuit protocol described above with reference to FIG. 5. The private union garbled circuit protocol can be configured to produce a plurality of secret-shared disjoint tuples based on the first tuple list and the second tuple list, then combine the plurality of secret shared disjoint tuples with either the first tuple list (e.g., according to the formula L₁ U L₂=L₂\L₁+L₁) or with the second tuple list (e.g., according to the formula L₁ U L₂=L₁\L₂+L₂), thereby generating the secret-shared union tuple list. This private union garbled circuit protocol can comprise a modified private set intersection garbled circuit protocol, similar to the circuit-PSI framework described in [8]. At the end of step 708, the first party computer and second party computer can learn secret shares of the secret-shared union tuple list, which they can then provide to the multi-party computation network, enabling the multi-party computation network to perform parallel private graph analysis on the secret-shared union tuple list.

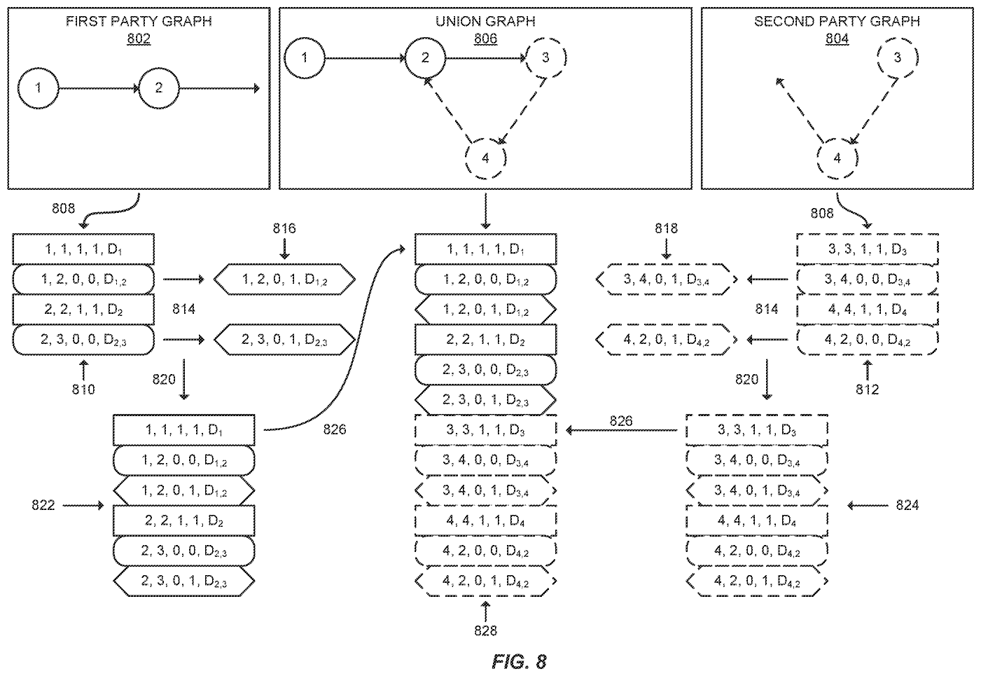

The process of tuple duplication (step 706) and generating the union tuple list (step 708) is described in more detail with reference to FIG. 8, which visually summarizes the setup steps described above.

At step 808, the first party computer and the second party computer can represent the first party graph 802 and the second party graph 804 as a first party tuple list 810 and a second party tuple list 812 respectively. As described above, each tuple in the tuple lists may correspond to a graph element (e.g., a vertex or edge) in the corresponding graph. Each tuple may comprise an ordered list of elements in the form (u, v, isVertex, isOriginal, data), where u is a vertex, v is a connected vertex pointed at by a directed edge, isVertex is a bit designating whether the tuple corresponds to a vertex (1 for vertices, 0 for edges), isOriginal is a bit designating whether an edge tuple is a duplicated edge tuple (0 for an original edge tuple, 1 for a duplicated edge tuple, and 1 for vertices), and data (sometimes represented as Du or Du, v) is data associated with the particular graph element.

For an application such as cycle detection using the Rocha-Thatte method, data may comprise a list of received vertex identifiers, used to identify if a cycle exists in the graph. For a vertex tuple, u and v may both comprise u, e.g., (u, u, 1, 1, Du). By comparison, an original edge tuple may comprise e.g., (u, v, 0, 0, Du,v) and a duplicated edge tuple may comprise e.g., (u, v, 0, 1, Du,v). In FIG. 8, each vertex tuple is represented by a rectangle with sharp corners. Each original edge tuple is represented as a rectangle with rounded corners. Each duplicated edge tuple is represented as a wide hexagon. First party tuples comprise a solid border, while second party tuples comprise a dashed border.

Each party can use any appropriate means to convert their respective graph into a representative tuple list. In some embodiments, each party may already represent their respective graphs as a tuple list. As such, step 808 may be optional.

At step 814, each party can duplicate each of the edge tuples in the first party tuple list 810 and second party tuple list 812, thereby generating one or more duplicate first edge tuples 816 and one or more duplicate second edge tuples 818. As described above, edge tuple duplication enables the “Scatter” and “Gather” steps of an SGA parallel private graph analysis method to be combined into a single “Scatter-Gather” step. This halves the number of oblivious shuffling operations that need to be performed, and consequently improves the speed and efficiency of the iterative scatter-gather approach.

Afterwards, at step 820, the first party can combine the first party tuple list 810 and the one or more duplicated first edge tuples 816 to generate an expanded first party tuple list 822. Likewise, the second party can combine the second party tuple list 812 and the one or more duplicated second edge tuples 818 to generate an expanded second party tuple list 824.

At step 826, the first party and the second party can generate a secret-shared union tuple list 828 using garbled circuits, such as the modified circuit-PSI protocol described above. The secret-shared union tuple list 828 can comprise a tuple list corresponding to the union graph 806 and include the duplicated edge tuples. The secret-shared union tuple list 828 can be generated according to a set equation such as A U B=A\B+B, where A represents the expanded first party tuple list 822 and B represents the expanded second party tuple list 824. As an alternative, the secret-shared union tuple list 828 can be generated using the set equation A U B=B\A+A, or any other appropriate set formulation.

It is not strictly necessary for the first party and second party to generate the duplicated first party edge tuples and the duplicated second party edge tuples prior to determining the union of their respective tuple lists. Instead, the edge tuples can be duplicated and included in the union tuple list after the union tuple list has been determined, using any appropriate private data duplication method.

Returning to FIG. 7, at step 710, the first party computer and second party computer can transmit the secret-shared union tuple list to the multi-party computation network, such that the multi-party computation network receives the secret-shared union tuple list. This transmission can comprise, for example, the first party computer and second party computer transmitting the secret shares corresponding to the secret-shared union tuple list to the computer systems that make up the multi-party computation network (e.g., the computer systems depicted in FIGS. 2 and 3).

At step 712, if the edge tuples were not duplicated at step 706, the multi-party computation network can generate a plurality of secret-shared duplicate edge tuples by duplicating the plurality of secret-shared edge. The multi-party computation network can perform this step using any appropriate private data duplication technique. Afterwards, the multi-party computation network can include the plurality of secret-shared duplicate edge tuples in the secret shared union tuple list.

### 3. Sort and Determine Permutations

At step 714, the multi-party computation network can obliviously sort the secret-shared union tuple list into a first ordering, thereby generating a first permutation corresponding to the first ordering. During the computation phase, the first permutation can enable the multi-party computation network to obliviously shuffle the secret-shared union tuple list into the first ordering, prior to a combined Scatter-Gather step. Because oblivious shuffling generally requires less operations than oblivious sorting, sorting the secret-shared union tuple list to determine a permutation, prior to the computation phase, enables the substitution of oblivious shuffling for oblivious sorting, thereby reducing execution time.

In the first ordering, each secret-shared vertex tuple of a plurality of secret-shared vertex tuples in the secret-shared union tuple list may be preceded by one or more corresponding secret-shared edge tuples of a plurality of secret-shared edge tuples in the secret-shared union tuple list, and may be followed by one or more corresponding secret-shared duplicate edge tuples (e.g., generated at step 706 or 712) of a plurality of secret-shared duplicate edge tuples. In other words, the first ordering may comprise the (G*WY*)* ordering described in Section C above.

At step 716, the multi-party computation network can obliviously sort the secret-shared union tuple list into a second ordering, thereby generating a second permutation corresponding to the second ordering. During the computation phase, the second permutation can enable the multi-party computation network to obliviously shuffle the secret-shared union tuple list into the second ordering, prior to a combined Scatter-Gather step.

In the second ordering, each secret-shared vertex tuple of the plurality of secret-shared vertex tuples in the secret-shared union tuple list can be preceded by one or more corresponding secret-shared duplicate edge tuples of the plurality of secret-shared duplicate edge tuples and followed by one or more corresponding secret-shared edge tuples of the plurality of secret-shared edge tuples. In other words, the second ordering may comprise the (Y*WG*)* ordering described in Section C above.

Steps 714 and 716 can be implemented using any appropriate oblivious sorting methods or techniques, such as those disclosed by Chida et al. [2]. Chida et al. implements oblivious radix sorting of secret-shared keys. Secret-shared tuples in the secret-shared union tuple list can be sorted using a key-based sorting scheme. For a W-tuple (a vertex tuple) i, the value i∥N can be used as its key. For a Y-tuple (a duplicate edge tuple) (i, j) the value i∥(j+N) as its key, and for a G-tuple (an original edge tuple) (i, j) the value j∥(N−i) can be used as its key. In each case, N refers to the total number of tuples in the tuple list. Note that the order of the G-tuples can be inverted (i.e., N−i). The tuple list can be sorted per their respective keys.

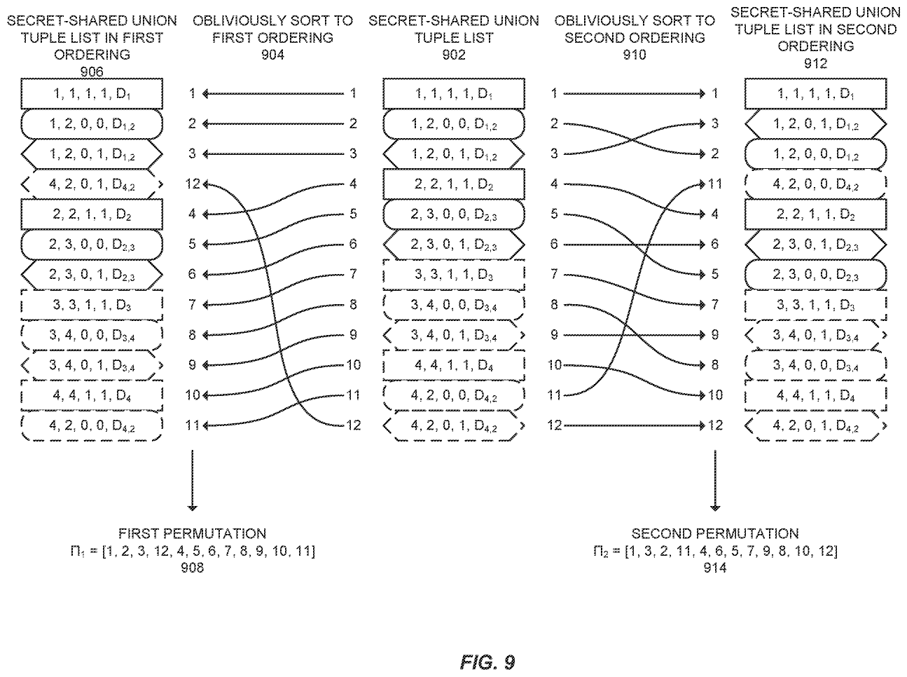

The process of sorting the union tuple list into the first ordering and second ordering, and generating the first permutation Π₁ and second permutation Π₂ (steps 714 and 716) is described, visually, with reference to FIG. 9.

Each ordering may facilitate performing the combined Scatter-Gather step as described below. In the first ordering, each vertex tuple (i.e., W tuple) may be preceded by original edge tuples that corresponds to directed edges that “point toward” that particular vertex tuple (i.e., G tuples), and followed by duplicate edge tuples that correspond to directed edges that “point away” from that particular vertex tuple (i.e., Y tuples). Using this notation, the first ordering 906 has the pattern “WYGGWYGWYGWY” which can be generalized to the pattern-form (G*WY*)* (i.e., any number of G tuples, followed by a W tuple, followed by any number of Y tuples, followed by any number of instances of a similar sequence of tuples).

In the second ordering 912, each vertex tuple, (i.e., W tuple) may be preceded by duplicate edge tuples that correspond to directed edges that point toward that particular vertex tuple (i.e., Y tuples), and followed by original edge tuples that correspond to directed edges that “point away” from that particular vertex tuple (i.e., G tuples). Using this notation, the second ordering 912 has the pattern “WGYYWGYWGYWG” which can be generalized to the pattern-form (Y*WG*)* (i.e., any number of Y tuples, followed by a W tuple, followed by any number of G tuples by any number of instances of a similar sequence of tuples). The transformation or primary difference between the first ordering 906 and the second ordering 912 can be characterized by “swapping” each original edge tuple for its corresponding duplicate edge tuple, and vis versa.

The particular micro or macro ordering of tuples within each particular list state may not be relevant, e.g., provided that the first ordering 906 is in a (G*WY*)* pattern, it may not matter whether a tuple corresponding to “vertex 3” precedes a tuple corresponding to “vertex 4” or vis versa. For ease of illustration, the tuple lists presented in FIG. 9 are presented in ascending order, such that the tuple corresponding to vertex 1 appears in the list before the tuple corresponding to vertex 2, etc. Likewise, the tuple corresponding to edge (3, 4) appears in the list before the tuple corresponding to edge (3, 5).

As stated above, at step 904, a multi-party computation network can obliviously sort the secret-shared union tuple list 902 into the first ordering 906. From the first ordering 906, the multi-party computation network can determine a first permutation 908 that can be used to obliviously shuffle the secret-shared union tuple list 902 into the first ordering 906 during the computation phase. The first permutation 908 may be stored by the multi-party computation network in secret-shared form.

At step 910, a multi-party computation network can obliviously sort the secret-shared union tuple list 902 into the second ordering 912. From the second ordering, the multi-party computation network can determine a second permutation 914 that can be used to obliviously shuffle the secret-shared union tuple list 902 into the second ordering 912 during the computation phase. The second permutation 914 may be stored by the multi-party computation network in a secret-shared form.

### 4. Prepare Processor Operations Using Tuple States

Returning to FIG. 7, at step 718, the multi-party computation network can determine a plurality of tuple states corresponding to the secret-shared tuples in the secret-shared union tuple list. These tuple states can be used to generate operational instructions for a pool of processors (associated with the multi-party computation network) that can process the secret-shared union tuple list during the computation phase. As a result of determining these tuple states prior to the computation phase, the processors do not need to do so during each operation of the computation phase, thereby reducing the number of operations performed and increasing the overall speed and efficiency of the multi-party graph analysis method.

A tuple state may indicate whether a corresponding secret-shared tuple comprises a vertex tuple (W tuple), original edge tuple (G tuple) or duplicate edge tuple (Y tuple). Typically, when the tuples are in secret-shared form, the tuple state of a particular tuple cannot be readily determined, without performing some operation or protocol (e.g., a garbled circuit protocol) to determine these tuple states. This has some implications for the multi-party computation process, particularly the combined Scatter-Gather step, as described in Section E below.

In general terms, during the computation phase, the secret-shared union tuples in the secret-shared union tuple list are divided among a pool of processors, such that each processor receives, e.g., two secret-shared tuples. Each processor then performs some operation based on the tuples they received, which is contextual on the tuple state (e.g., W, G, or Y) of those tuples. In doing so, the pool of processors can perform the combined Scatter-Gather step and the Apply step in parallel, decreasing the total execution time.

For example, assume that a processor receives a W tuple and a G tuple. The receiving processor may scatter the data from the W tuple to the G tuple as part of the combined Scatter-Gather step. Alternatively, assume a processor receives two secret-shared W tuples. In this case, there is no corresponding operation (e.g., either Scatter or Gather) that needs to be performed. W tuples Scatter to either Y or G tuples and gather from either G or Y tuples. A processor with two W tuples cannot perform either the Scatter or Gather operations using either of their tuples. As such, the types of tuples that a processor receives or is assigned influences the operations that the processor performs.

However, it is not necessary for the processors to determine the state of the tuples during the computation phase. Because the first ordering and second ordering are known (via the first permutation and second permutation), each operation that each processor performs during the computation phase can be determined in advance based on these orderings and the tuple states, provided that the processors are assigned inputs according to a defined pattern (e.g., a first processor receives the first two secret-shared tuples in the union tuple list, a second processor receives the second two tuples in the union tuple list, etc.).

Broadly, instead of each processor receiving its respective tuples, determining the tuple state corresponding to those two tuples, then performing an operation based on the determined tuple states, each processor can instead be assigned an operation in advance, based on the tuple states determined at step 718. This both reduces the number of operations performed in the computation phase and prevents any information about the underlying union graph from being leaked during the computation phase.

### E. Computation Phase

After the setup phase has been performed and the secret-shared union tuple list has been prepared for analysis, a multi-party computation network (such as multi-party computation network 206 from FIG. 2 or 302 from FIG. 3) can perform multi-party parallel private graph analysis on the secret-shared union tuple list. In some embodiments, this analysis can comprise a three-party honest majority semi-honest multi-party computation. In some embodiments, the parallel private graph analysis may comprise executing a cycle detection method on a secret-shared union tuple list of financial transfer data. This cycle detection method may result in the detection of one or more directed cycles, which may comprise evidence of money laundering activities. However, as described in Section F, other graph methods can be performed, such as private matrix factorization methods, network ranking methods, and frequency histogram generation methods.

Broadly, the computation phase involves the multi-party computation network dividing the secret-shared union tuple list among a pool (or plurality) of processors, then using the pool of processors to obliviously shuffle the secret-shared union tuple list into the first ordering using the first permutation. Afterwards, the pool of processors can perform the combined Scatter-Gather step, and the Apply step on the tuples in the secret-shared union tuple list. After performing these steps, the secret-shared union tuple list can be obliviously shuffled into the second ordering, and the process can be repeated until some terminating condition (e.g., the detection of one or more cycles) has been met. FIG. 10 summarizes this process.

At step 1004, the multi-party computation network can obliviously shuffle the secret-shared union tuple list into the first ordering using the first permutation. Afterwards, at step 1008, the multi-party computation network can perform a combined Scatter-Gather step on the secret-shared union tuple list, then perform an Apply step on the secret-shared union tuple list.

The Scatter-Gather step may be based on the ordering of the secret-shared union tuple list (e.g., the first ordering versus the second ordering), and is generally illustrated by the arrows in FIG. 10. In step 1008, each vertex tuple (tuples 1, 5, 8, and 11) can scatter data to subsequent duplicate edge tuples (2, 6, 9, and 12). Likewise, each vertex tuple can gather data from preceding original edge tuples (3, 4, 7, and 10), completing both the Scatter and Gather step in a single linear scan of the secret-shared union tuple list. Afterwards, a real Apply function can be applied to each vertex tuple (e.g., checking if the data at any vertex tuple is indicative of a cycle), and a dummy Apply function can be applied to each edge tuple, thereby preserving obliviousness.

At step 1010, the multi-party computation network can obliviously shuffle the secret-shared union tuple list into the second ordering using the second permutation. Afterwards, at step 1008, the multi-party computation network can perform a combined Scatter-Gather step on the secret-shared union tuple list, then perform an Apply step on the secret-shared union tuple list.

Like in step 1008, the Scatter-Gather step at step 1014 may be based on the ordering of the secret-shared union tuple list, and is generally illustrated by the arrows in FIG. 10. In step 1014, each vertex tuple (still 1, 5, 8 and 11) can scatter data to subsequent original edge tuples (now tuples 2, 6, 9, and 12 due to the second ordering) and gather data from preceding duplicate edge tuples (now tuples 3, 4, 7, and 10), completing both the Scatter and Gather steps in a single linear scan of the secret-shared union tuple list. Afterwards, a real Apply function can be applied to each vertex tuple, and a dummy Apply function can be applied to each edge tuple, thereby preserving obliviousness.

Steps 1005, 1008, 1010, and 1014 can be repeated until a terminating condition has been achieved. Checking for this terminating can be performed by the Apply function during the Apply step. The terminating condition can comprise, for example, the detection of one or more cycles, a Rocha-Thatte halting condition (described in Section C above) or a cycle detection message size exceeding a predetermined value (also described in Section C above).

### 1. Multi-Party Computation Flowchart

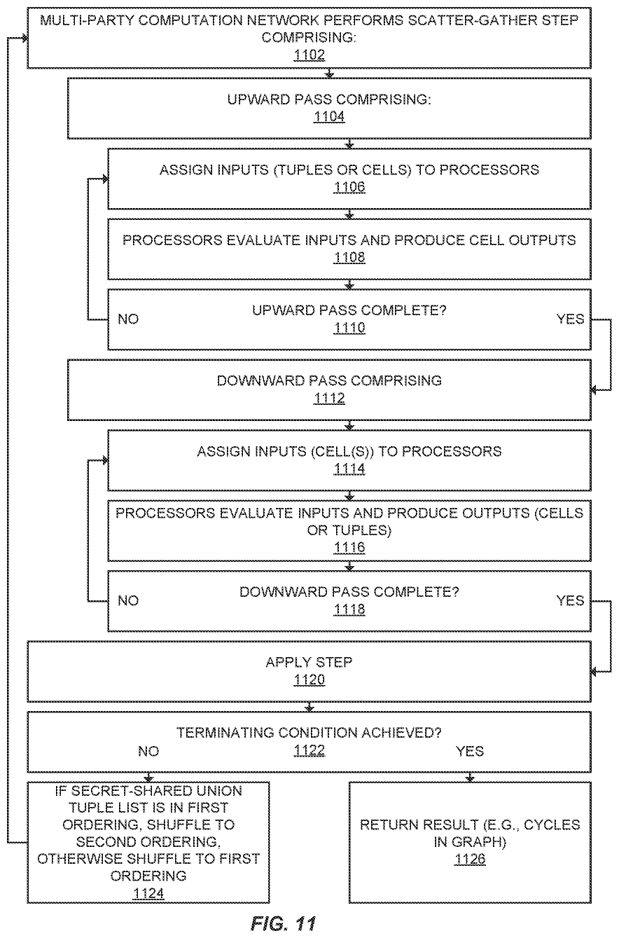

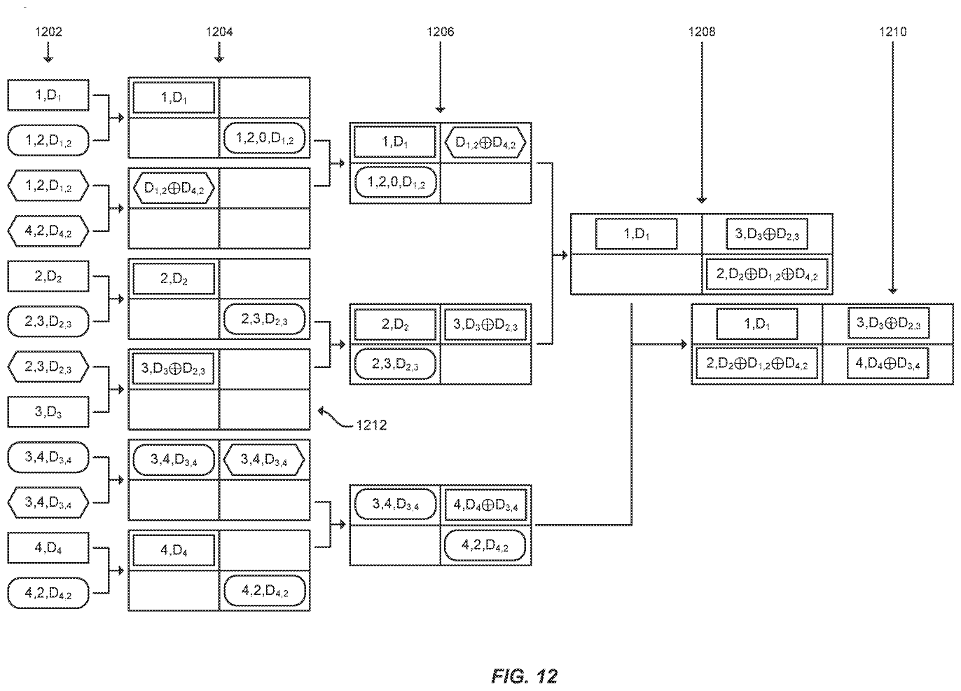

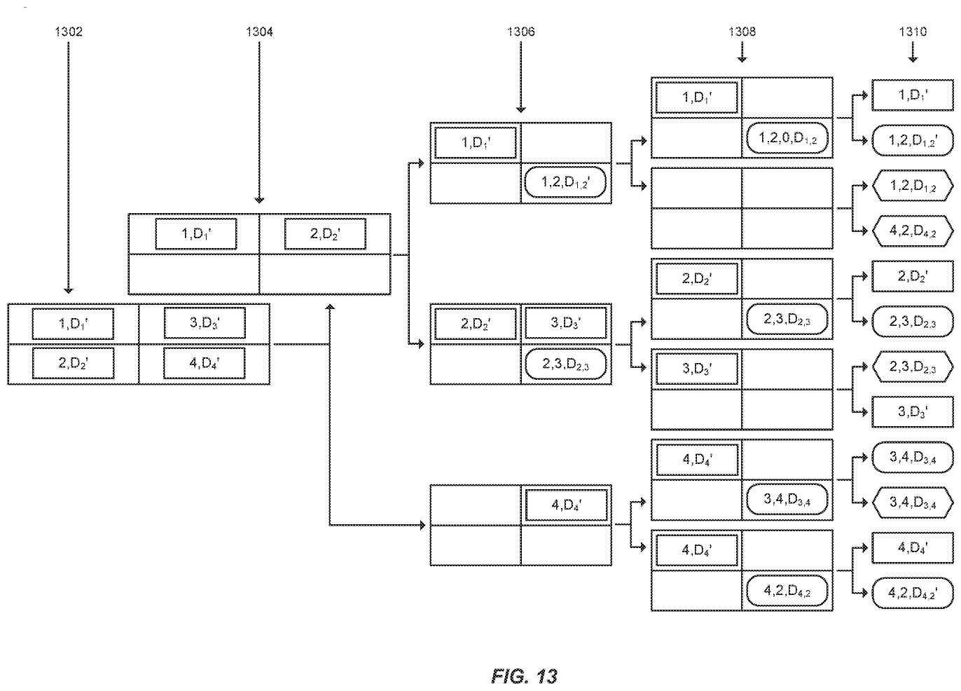

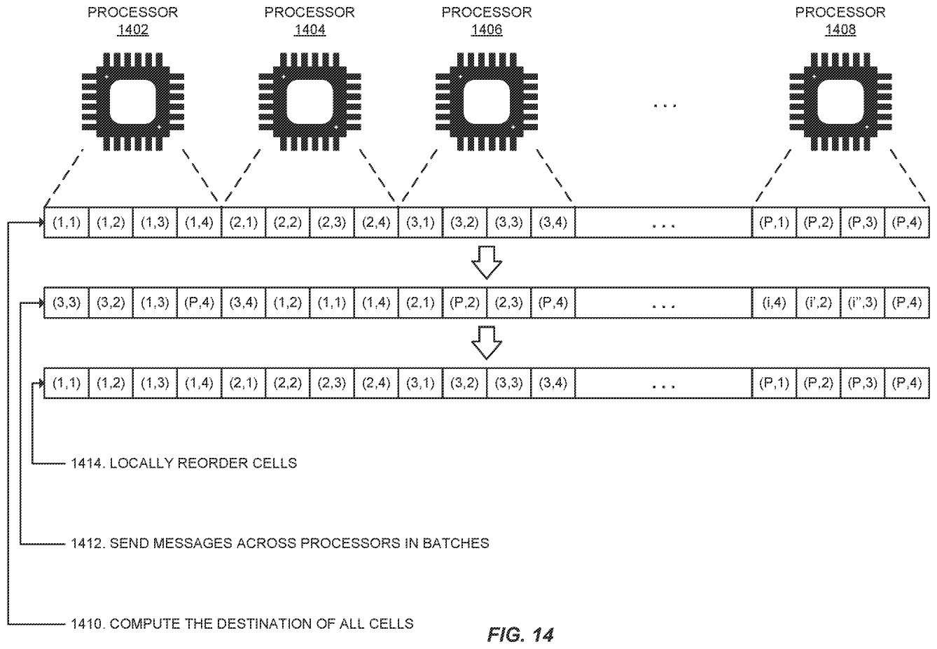

The computation phase is now described in more detail with reference to the flowchart of FIG. 11, as well as FIGS. 12-14. The combined Scatter-Gather step, described above, can be further divided into an “upward pass” and “downward pass” which are described with reference to FIGS. 12 and 13 respectively. FIG. 14 illustrates how a pool of processors can collectively obliviously shuffle a secret-shared union tuple list.

FIG. 12 shows a flowchart of an exemplary method of performing a parallel private graph method according to embodiments. The parallel private graph method can comprise a cycle detection method, such as a Rocha-Thatte cycle detection method, as described above. However, the parallel private graph method can also comprise any other appropriate graph analysis method, such as a private matrix factorization method as described below in Section F. In FIG. 12, it is assumed that the secret-shared union tuple list is already in one of the two orderings (i.e., the first ordering or the second ordering) described above.

The method can comprise two primary steps, a combined Scatter-Gather step 1102 and an Apply step 1120. The Scatter-Gather step 1102 can comprise two sub-steps: an upward pass step 1104 and a downward pass step 1112. Performing these two sub-steps, in sequence, can result in updating the data associated with each tuple in the secret-shared union tuple list in accordance with an iteration of both the Scatter and Gather SGA steps.

### 2. Upward Pass

The upward pass generally comprises the implicit construction of the root node (or cell) of a binary tree, using each secret-shared union tuple in the secret-shared union tuple list as a leaf node. From this root cell, a new binary tree can be constructed, for which the leaf nodes comprise updated secret-shared union tuples in an updated secret-shared union tuple list. In this way, performing the upward pass, followed by the downward pass results in the secret-shared union tuple list data being updated in accordance with one iteration of both the Scatter and Gather steps.

Provided that a sufficient number of processors are available to the multi-party computation network, the upward pass and the downward pass may each comprise log N time steps, where N is the total number of elements in the secret-shared union tuple list. Thus the upward pass and downward pass collectively can be completed in 2 log N time steps.

The upward pass step 1104 generally comprises three steps 1106-1110. Initially, a “set of inputs” may be defined as a plurality of secret-shared union tuples in the secret-shared union tuple list. At step 1106, the set of inputs can be divided among a plurality of processors associated with the multi-party computation network. Generally, each processor is tasked with processing its respective inputs, enabling the secret-shared union tuple list to be processed in parallel. In some cases, preferably, each processor can be assigned two inputs, as this may achieve faster processing speed. However, in many practical use cases, the multi-party computation network may not have access to a large enough pool of processors. As such, each processor may be assigned more than two inputs.

At step 1108, the multi-party computation network, using the pool of processors, can process the set of inputs using a cycle detection method (or any other appropriate graph analysis method) and based on the current ordering of the secret-shared union tuple list, thereby producing a first set of outputs. The set of outputs may comprise less outputs than the set of inputs comprises inputs. These outputs may comprise data values referred to as cells. In some embodiments, the set of outputs may comprise roughly half as many cells as inputs (cells or tuples) in the set of inputs. The multi-party computation network can then define the set of inputs as the set of outputs, enabling the upward pass to be repeated until the set of inputs comprises a single input, the root cell of the implicitly constructed binary tree.

A cell, mentioned above, generally comprises the data element used to represent an internal node of the binary tree. A cell can comprise two persistent storage elements and two ephemeral storage elements. For a given processor, its inputs and the current list ordering influence the data stored in these persistent and ephemeral storage elements. For example, as described above with reference to FIG. 10, in the first ordering, vertex tuples may scatter to duplicate edge tuples and gather from original edge tuples. Hence, if a processor is assigned a vertex tuple and a duplicate edge tuple, it may generate a cell output consistent with a scatter operation from the vertex tuple to the duplicate edge tuple. However, in the second ordering, vertex tuples may scatter to original edge tuples and gather from duplicate edge tuples. Hence, if a processor is assigned a vertex tuple and a duplicate edge tuple, it may generate a cell output consistent with a gather operation from the duplicate edge tuple to the vertex tuple.

While processing their respective inputs during the upward pass, the processors may adhere to a set of propagation rules, defined in the upward propagation rules table further below. The propagation rules table can indicate the corresponding cell output for a given set of inputs during the upward pass.

At step 1108, the multi-party computation network can use the plurality of processors to determine if the upward pass has been completed. As described above, the general goal of the upward pass is to construct a root cell, which can be used to reconstruct updated secret-shared union tuples. In each iteration of the upward pass, because the number of output cells is less than the number of inputs (tuples or cells), and because the set of outputs can define the set of inputs in the following iteration, eventually the set of inputs can comprise a single input (the root cell), at which point the upward pass has been completed. If the upward pass has been completed, the method can proceed to the downward pass, step 1112, otherwise the method can return to step 1106 and the upward pass can be repeated until the set of inputs comprises the root cell.

FIG. 12 shows a visualization of the upward pass (steps 1104-1110) on the exemplary union graph 106 of FIG. 1.

“Level indicator” 1202 shows the initial set of inputs, a secret-shared union tuple list in the first ordering comprising 12 tuples. Each set of two consecutive tuples can be assigned to a processor from among the pool of processors. The pool of processors can process the inputs and produce a set of 6 output cells, indicated by level indicator 1204. The two persistent and two ephemeral storage elements are displayed as subdivisions in the output cells. These storage elements can be filled with data from the input tuples in accordance with the upward propagation rules table presented below. For example, counting from the top of level indicator 1202, the 7^{th} and 8^{th} secret-shared input tuples are assigned to the same processor, which produces output cell 1212. The 7^{th} and 8^{th} tuples comprise an original edge tuple corresponding to the edge between vertices 2 and 3 and a vertex tuple corresponding to vertex 3. In the first ordering, the vertex tuples gather from original edge tuples. Hence, in cell 1212, one persistent storage element comprises a vertex tuple, in which the data corresponding to the vertex tuple and the original edge tuple (D₃ and D_{2,3} respectively) has been combined according to the gather function ⊕ (D₃ ⊕ D_{2,3}). This is consistent with the second propagation rule in the upward propagation rules table (i.e., the rule at REF ID 104) presented below.

Subsequently, after the pool of processors corresponding to the multi-party computation network has generated the set of outputs at level indicator 1204, the multi-party computation network can divide those outputs among the processors and repeat the upward pass, using the set of outputs as the set of inputs. This can result in the set of output cells indicated at level indicator 1206. This can be repeated two more times until the final output, the root cell of the implicitly constructed binary tree is produced at level indicator 1210.

### a) Upward Propagation Rules Table

The following table details some of the rules that describe how a processor can process two inputs (either tuples or cells) during the upward pass phase. These rules are listed by reference ID, and generally describe the result and storage result (i.e., the output) corresponding to the state of the inputs and the data stored in the inputs persistent and ephemeral storage. Generally speaking, when inputs are organized in sequence, the “left input” refers to the input that is located earlier in the sequence (e.g., input n) and the “right input” refers to the input that is located later in the sequence (e.g., input n+1).

| REF ID | Left Input | Right Input | Result | Storage |
|---|---|---|---|---|
| 102 | g₁ | g₂ | g₁ ⊕ g₂ | |
| 104 | g | w | g ⊕ w | |
| 106 | g₁ | w \|\| g₂ | (g₁ ⊕ w) \|\| g₂ | |
| 108 | g | w \|\| y | g ⊕ w | (; y) |
| 110 | w | g | w \|\| g | |
| 112 | w₁ | w₂ | w₁ \|\| w₂ | |
| 114 | w₁ | w₂ \|\| g | w₁ \|\| g | (; w₂) |
| 116 | w | y \|\| g | w \|\| g | (; y) |
| 118 | w₁ | w₂ \|\| y | w₁ \|\| w₂ | (; y) |
| 120 | w | y | w | (; y) |
| 122 | y | g | y \|\| g | |
| 124 | y | w | y \|\| w | |
| 126 | y | w \|\| g | y \|\| g | (; w) |
| 128 | y₁ | w \|\| y₂ | y₁ \|\| w | (; y₂) |
| 130 | y₁ | y₂ | y₁ | |
| 132 | w \|\| g₁ | g₂ | w \|\| (g₁ ⊕ g₂) | |
| 134 | w₁ \|\| g | w₂ | w₁ \|\| (g ⊕ w₂) | |
| 136 | w₁ \|\| g₁ | w₂ \|\| g₂ | w₁ \|\| g₂ | (; g₁ ⊕ w₂) |
| 138 | w₁ \|\| g₁ | w₂ \|\| y₁ | w₁ \|\| (g₁ ⊕ w₂) | (; y₁) |
| 140 | w₁ \|\| g₁ | w₂ \|\| w₃ | w₁ \|\| w₃ | (; g₁ ⊕ w₂) |
| 142 | w \|\| y | g | w \|\| g | (y; ) |
| 144 | w₁ \|\| y | w₂ | w₁ \|\| w₂ | (y; ) |
| 146 | w₁ \|\| y | w₂ \|\| g | w₁ \|\| g₂ | (y; w₁) |
| 148 | w₁ \|\| y₁ | w₂ \|\| y₂ | w₁ \|\| w₂ | (y₁; y₂) |
| 150 | w \|\| y₁ | y₂ | w | (y₁; y₂) |
| 152 | y \|\| g₁ | g₂ | y \|\| (g₁ ⊕ g₂) | |
| 154 | y \|\| g | w | y \|\| (g ⊕ w) | |
| 156 | y \|\| g₁ | w \|\| g₂ | y \|\| g₂ | (; g₁ ⊕ w) |
| 158 | y₁ \|\| g₁ | w \|\| y₂ | y \|\| (g₁ ⊕ w) | (; y) |
| 160 | y \|\| w | g | y \|\| (w ⊕ g) | |
| 162 | y \|\| w₁ | w₂ | y \|\| w₂ | (w₁; ) |
| 164 | y \|\| w₁ | w₂ \|\| g₂ | y \|\| g₂ | (w₁; w₂) |
| 166 | y₁ \|\| w₁ | w₂ \|\| y₂ | y₁ \|\| w₂ | (w₁; y₂) |
| 168 | w₁ \|\| w₂ | g | w₁ \|\| g | (w₂; ) |
| 170 | w₁ \|\| w₂ | w₃ | w₁ \|\| w₃ | (w₂; ) |
| 172 | w₁ \|\| w₂ | w₃ \|\| g₂ | w₁ \|\| g₂ | (w₂; w₃) |
| 174 | w₁ \|\| w₂ | w₃ \|\| y | w₁ \|\| w₃ | (w₂; y) |
| 178 | w₁ \|\| w₂ | y | w₁ \|\| w₂ | (; ) |

### 3. Downward Pass

After completing the upward pass, the multi-party computation network can perform a downward pass comprising steps 1112-1118. The downward pass generally comprises the construction of a plurality of updated secret-shared union tuples using the root cell generated during the upward pass phase. These updated secret-shared union tuples can comprise tuples with data updated in a manner consistent with Scatter and Gather operations.

At step 1114, the multi-party computation network can divide a set of inputs among the plurality of processors. Initially, this set of inputs can comprise a single input, the root cell generated as a result of the upward pass.

At step 1116, the multi-party computation network, using the plurality of processors, can process the set of inputs using a cycle detection method (or any other appropriate graph analysis method) and based on the current ordering of the secret-shared union tuple list, thereby producing a second set of outputs. The set of outputs may comprise cells or tuples and may comprise more outputs than the set of inputs comprises inputs. In some embodiments, the set of outputs may comprise roughly twice as many outputs as inputs in the set of inputs. The multi-party computation network can then define the set of inputs as the set of outputs, enabling the downward pass to be repeated until the set of inputs comprises an updated plurality of union tuples in the secret-shared union tuple list.

At step 1118, the multi-party computation network can use the pool of processors to determine if the downward pass has been completed. As described above, the general goal of the downward pass is to construct the updated plurality of union tuples using the root cell generated during the upward pass. In each iteration of the downward pass, because the number of outputs is less than the number of inputs, and because the set of outputs can define the set of inputs in the following iteration, the set of inputs can grow until it is the size of the original set of inputs during the upward pass, at which point the set of inputs comprises the updated plurality of union tuples, at which point the downward pass has been completed. If the downward pass has been completed, the method can proceed to Apply step 1120, otherwise the method can return to step 1114 and the downward pass can be repeated until the set of inputs comprises the updated plurality of union tuples.

FIG. 13 shows a visualization of the downward pass (steps 1112-1118) on the exemplary root cell generated by the upward pass visualized in FIG. 12.

Level indicator 1302 shows the initial set of inputs, comprising the root cell generated during the upward pass. This root cell can be assigned to a single processor, which can process the root cell and produce two outputs, one shown at level indicator 1304 and the other shown at level indicator 1306. As in FIG. 12, the two persistent and two ephemeral storage elements are displayed as subdivisions in the output cells. These storage elements can be filled with data from the input cell in accordance with the downward propagation rules table presented below. For example, the top cell at level indicator 1308 can be processed to produce the first two tuples (a vertex tuple and a duplicate edge tuple) at level indicator 1310. This is consistent with the fourth propagation rule in the downward pass propagation rules table (i.e., the rule at REF ID 206) presented below.

Subsequently, after the plurality of processors corresponding to the multi-party computation network has generated the set of outputs at level indicator 1304, the multi-party computation network can divide these outputs among the processors and repeat the downward pass, using the set of outputs as the set of inputs. This can result in the set of output cells indicated at level indicator 1306. This can be repeated two more times until the final outputs, the updated plurality of secret-shared union tuples is produced at level indicator 1310.

### a) Downward Propagation Rules Table

The following table details some of the rules that describe how a processor can process two inputs (either tuples or cells) during the downward pass phase. These rules are listed by reference ID, and generally describe the result and storage result (i.e., the output) corresponding to the state of the inputs and the data stored in the inputs persistent and ephemeral storage. Generally speaking, when inputs are organized in sequence, the “left input” refers to the input that is located earlier in the sequence (e.g., input n) and the “right input” refers to the input that is located later in the sequence (e.g., input n+1).

| REF ID | Parent Input | Storage | Left Output | Right Output |
|---|---|---|---|---|
| 200 | g₁ | | | |
| 202 | w | (y₁; y₂) | w | w |
| 204 | w₁ | (; ) | w | |
| 206 | w₁ | (; y) | w | y |
| 208 | w₁ | (; w₂) | w₁ | w₂ |
| 210 | w₁ \|\| w₂ | (w₃; ★) | w₁ \|\| w₃ | w₂ |
| 212 | w₁ \|\| w₂ | (★; w₃) | w₁ | w₃ \|\| w₂ |
| 214 | w₁ \|\| w₂ | ★ | w₁ | w₂ |
| 216 | w \|\| g | (; ) | w | |
| 218 | w₁ \|\| g | (; w₂) | w₁ | w₂ |
| 220 | w \|\| g | (y; ) | w | |
| 222 | w₁ \|\| g | (w₂; ) | w₁ \|\| w₂ | |
| 224 | w₁ \|\| g | (w₂; w₃) | w₁ \|\| w₂ | w₃ |

### 4. Apply Step and Terminating Condition Check

After the upward pass and downward pass have been completed, at the Apply step 1120, the multi-party computation network can divide the secret-shared union tuple list (now comprising an updated plurality of union tuples as a result of the apply step) among the plurality of processors, then apply an apply function to each tuple of the updated plurality of union tuples. The apply function depends largely on the specifics of the multi-party graph analysis method (e.g., cycle detection for anti-money laundering) being performed. For an apply function corresponding to the Rocha-Thatte method, the apply function may check whether the data associated with each vertex tuple contains a list of vertex identifiers that indicate a cycle, e.g., a list of vertex identifiers such as [1, 2, 3, 1]. The apply function may produce a result of the parallel private graph method if a terminating condition has been achieved. This terminating condition, described in more detail below, may indicate that the parallel private graph method has been completed. The multi-party computation network may determine if the terminating condition has been achieved by evaluating data associated with the updated plurality of union tuples (e.g., corresponding to the data elements D in the data-augmented directed graph corresponding to the secret-shared union tuple list). For a Rocha-Thatte implementation, the terminating condition may comprise each vertex halting participation in the Rocha-Thatte method as described above in Section C, or a cycle detection message size exceeding a predetermined value or any other appropriate terminating condition.

At step 1122, the multi-party computation network can determine if a terminating condition has been achieved. If the terminating condition has been achieved, the flowchart can proceed to step 1126 (described below) and output the result of the private parallel graph analysis method (e.g., a list of cycles) to the first party computer and the second party computer, otherwise the flowchart can proceed to step 1124, the secret-shared union tuple list can be obliviously shuffled, and the computation phase can be repeated until the terminating condition has been achieved.

In some embodiments, the terminating condition check can be integrated into the apply function applied to the secret-shared vertex tuples at the Apply step 1120. The terminating condition may depend on the particular parallel private graph analysis method being performed. For example, the terminating condition for a cycle detection method may be different than the terminating condition for a matrix factorization method. For Rocha-Thatte cycle detection, the terminating condition could comprise, for example, each participating vertex “halting” participating in the cycle detection method, as described above in Section C. This condition may also be referred to as a halting condition. Additionally or alternatively, the terminating condition may comprise cycle detection messages exceeding a predetermined length (e.g., 8), as described above in Section C.

### 5. Oblivious Shuffling

At step 1124, if the terminating condition has not been achieved, the secret-shared union tuple list can be obliviously shuffled and the iterative Scatter-Gather-Apply approach (e.g., the combined Scatter-Gather step and the Apply step) can be repeated until the terminating condition has been achieved. If the secret-shared union tuple list is in the first ordering, the multi-party computation network can obliviously shuffle the secret-shared union tuple list into the second ordering using the second permutation. Otherwise, if the secret-shared union tuple list is in the second ordering, the multi-party computation network can obliviously shuffle the secret-shared union tuple list into the first ordering using the first permutation. The multi-party computation network can use any appropriate oblivious shuffling protocol, such as the oblivious shuffling protocol described by Chida et al. Afterwards, the flowchart can return to the beginning of the Scatter-Gather step 1102 and repeat until the terminating condition has been achieved.

At step 1126, if the terminating condition has been achieved, the multi-party computation network can return the results of the parallel private graph method to the first party computer and the second party computer, completing the computation phase. For a parallel private graph method corresponding to, e.g., Rocha-Thatte cycle detection used to detect money laundering activities in union financial transfer data graphs, the result may comprise a notification of money laundering, which may include a plaintext list of cycles detected in the secret-shared union tuple list.

As described above, rather than using oblivious sorting to convert the secret-shared union tuple list from the first ordering to the second ordering, the multi-party computation network can obliviously shuffle the secret-shared union tuple list using the first permutation and the second permutation determined during the setup phase. This can be more efficient, as the time complexity of oblivious shuffling is lower than the time complexity of oblivious sorting. FIG. 14 shows an exemplary parallelized shuffling protocol that can be used in some methods according to embodiments.

Broadly, during some methods according to embodiments, the multi-party computation network can assign tuples to a collection (or “pool”) of processors (e.g., processors 1402, 1404, 1406, and 1408). In FIG. 14, each processor is shown assigned a set of four tuples. The tuples are generally organized, from left to right, in an order consistent with the secret-shared union tuple list in some ordering (e.g., the first ordering). Consequently, when the secret-shared union tuple list is obliviously sorted into another ordering (e.g., the second ordering), each processor is expected, generally, to possess or otherwise be assigned a different set of tuples. As such, the oblivious shuffling process may involve processors 1402-1408 communicating and transmitting tuples to one another, so that each processor is assigned secret-shared tuples consistent with the current ordering of the secret-shared union tuple list.

At step 1410, each processor can compute the destination of all tuples. These destinations can be based on a processor ordering. For example, if processor 1402 processes the first four tuples, and processor 1404 possesses the second four tuples, if processor 1402 has a tuple (e.g. “tuple 2”) which will be “shuffled” to become the 7^{th} tuple (“tuple 7”), processor 1402 can determine that the destination of tuple is processor 1404. This determination can be made while the tuples are in secret-shared form, preventing any information from leaking during the shuffling protocol. Next, at step 1412, the processors can transmit the secret share tuples to their respective destinations in batches of messages.

Afterwards, at step 1414, each processor can locally reorder their respective tuples based on the shuffling order (i.e., permutation) completing the shuffling process.

### F. Other Applications

It should be understood that although embodiments have primarily been described with reference to the application of cycle detection in financial transfer graphs, embodiments can be used for other graph analysis applications. Generally, improvements to the SGA technique, such as combining the Scatter and Gather steps into a single step, can be used to improve many parallel privacy-preserving graph processing methods. Some particular applications, other than cycle detection, are described in more detail below.

### 1. Word Frequency Histogram

One exemplary application is the construction of a histogram of words across multiple documents, without revealing the text of each document. Each word can be assigned a numeric key, and a bipartite graph G can be constructed from the documents, in which edges connect keys to words. Rather than detecting cycles in the graph G using the Rocha-Thatte method, other methods can be employed to count the number of edges in the bipartite graph G, thereby counting the number of instances of each word in the documents. In one exemplary implementation, keys and words can be represented as 16-bit integers, and accumulators (i.e., key vertex data) can be stored using 20-bit integers.

### 2. Network Ranking Systems

Another exemplary application is ranking system in networks. Such ranking systems can be used for a variety of purposes, such as ranking the relative importance of websites on the Internet. Another example is ranking the social influence or popularity of individuals across multiple social networks. In such a scenario, multiple social networking companies may want to compute the social influence of uses on the aggregated network comprising a union graph corresponding to the union of their respective social networks. Each company may not want to reveal user or network data to the other participating companies.

The social networking companies could construct the private union graph of their social networks using some of the techniques described above. In such a union graph, vertices could correspond to users and edges could correspond to social connections (e.g., friendships) between the users. Then, instead of identifying cycles using the Rocha-Thatte method, a different method could be used that enables the calculation of a “rank” associated with each vertex (e.g., user) in the private union graph. Such a rank could be based on the number and “quality” of connecting edges, e.g., an edge connecting a user to a popular user may be more valuable to a user's rank than an edge connecting the user to a less popular user.

Each user could, for example, be identified using a 16-bit integer, one bit could be used as a vertex flag (e.g., “isVertex,” as described above), and a second bit could be used as a duplicate edge flag (e.g., “isOriginal,” as described above. The rank associated with each vertex (user) can be implemented using a 64-bit fixed point representation, with 40 fractional bits. Such a method could result in a plaintext list of users and their associated ranks.

### 3. Private Matrix Factorization

As another example, embodiments of the present disclosure can be used to execute parallel private graph methods comprising private matrix factorization methods. Embodiments can thereby be used to improve private matrix factorization [9] techniques. Matrix factorization is often used in recommender systems, such as recommender systems that recommend music or television shows based on music or televisions shows that users have previously listened to or watched. In matrix factorization, a sparse low-rank matrix can be split into two dense low-dimension matrices that, when multiplied, closely approximate the original matrix. These two low-dimension matrices can be used to train machine learning models to act as recommenders. In secure matrix factorization for recommender systems, a matrix can be factored and used to learn user or item feature vectors, while hiding both ratings and the individual items (e.g., television shows) that the user has rated.

A bipartite graph G can be constructed in which vertices represent users and rated items and edges connect those user and item vertices. In addition, a data value D can be associated with each vertex that contains a feature vector, corresponding to the vertex's respective row in the user/item factor matrix. Matrix factorization can be accomplished with gradient descent and alternating least squares (ALS) (see, e.g., [9]). In gradient descent, the gradient is computed for each rating separately, and then accumulated for each user and each item feature vector. As such, gradient descent can be implemented in a highly parallel manner. In ALS, the computation can be alternated between user feature vectors (assuming fixed item feature vectors) and item feature vectors (assuming fixed user feature vectors). For each step, a processor assigned to each vector can solve (in parallel) a linear regression using the data from its neighbors. Similar to the ranking example provided above, 16-bit integers can be used for vertex identifiers, and one bit can be used to represent is Vertex and isOriginal respectively. The user and item feature vectors can be ten-dimensional, and each element can be stored as a 40-bit fixed-point real number.

A secure implementation of matrix factorization using gradient descent has been studied by Nikolaenko et al., who constructed circuits of linear depth. The authors used a multi-core machine to exploit parallelization during sorting, and relied on shared memory across threads. This limits the ability to scale beyond a single machine, both in terms of the number of parallel processors (i.e., 32 processors) as well as input size (the authors considered no more than 17,000 ratings using a 128 GB RAM server).

### G. Evaluation and Performance Analysis

### 1. Parallel Oblivious Methods: Metrics

There are a variety of metrics that may be useful in evaluating the performance of parallel privacy-preserving graph analysis techniques. These metrics can include “total work,” “parallel time” and “communication cost.”

Total work broadly refers to an estimate of the total number of operations performed by computers or other systems when performing computations. Total work is often evaluated based on how the number of computations scale relative to the number of inputs N. “Big O” notation is often used to as an approximation or substitute for total work. An O(N) computation scales linearly with the number of inputs, while a O (N²) computation scales exponentially, and may take more work to complete than the O(N) computation.

Total work can be measured using a variety of means. For example, total work can be measured by evaluating the total number of operations on data elements (e.g., tuples) in the shared memory array. As another example, total work can also be measured by evaluating the size of a garbled circuit used to implement the oblivious cycle detection method. The total work of parallel oblivious operations can increase due to a variety of reasons, including the two that follow. The first is that the cost of parallelism can increase the total among of work that needs to be executed. The second is that the total work may increase due to the use of oblivious processing techniques. Oblivious processing techniques typically require more work than insecure processing techniques, because extra steps or operations are used to maintain obliviousness.

Parallel runtime can be measured as the total time required to execute parallel oblivious techniques, assuming a sufficient number of processors. When a parallel oblivious method is implemented using a garbled circuit, the parallel runtime is equivalent to the circuit's depth. The parallel runtime of an oblivious implementation of methods according to embodiments can be compared against an optimal parallel, insecure (e.g., non-oblivious) baseline implementation.

Communication cost can be measured as the total number of pairwise interactions between different processors from among the T processors participating in the oblivious parallel process. Communication costs can also be measured using the total amount of data sent to other devices.

### 2. Performance Analysis

As described above, 2 log N steps are sufficient to complete a single Scatter-Gather step. Because the tree size is at most 2×2N and at each internal node a constant number of operations are perform, the total work of a single iteration is O(N). The parallel time associated with methods according to embodiments is O (log N) and the underlying hidden constants are small.

Methods according to embodiments can be generalized to a case where the number of processors P<N. For any given P, each processor can be assigned a sub-tree which it evaluates serially. The subtree can be rooted at an internal node where the number of nodes at that level is less than P. For example, referring to FIG. 12, if P=3, then each processor can be assigned a distinct subtree rooted at nodes at level 3 (1206), each processor would then be responsible for processing four of the twelve tuples indicated at level 1 (1202).

As a result, with P processors, the parallel running time increases to 2 N/P+2 log (P). The total work is still O(N). For the purpose of comparison, when using conventional methods with M=|V|+|E| and P processors, the parallel time is O (M/P+log P). The total work using conventional methods under these conditions is 0 (P log P+M). As such, with conventional methods there is an inherent tradeoff between the parallel running time and total work. Embodiments of the present disclosure eliminate this trade-off and scale effectively with the total number of processors.

### a) Sparsity of Communication

In a distributed memory setting where memory is separated among the processors, conceptual “shared memory” can be implemented using inter-processor communication. One advantage of some embodiments of the present disclosure is that in every step during parallel computation, a processor only needs to communicate with one other processor. This is an improvement over convention methods, in which each processor may need to communicate with Log P processors. Reducing the number of communications increases the speed and efficiency at which graphs can be processed and cycles can be detected.

| System | Total Work | Parallel Time |
|---|---|---|
| Insecure | O(N) | O(log d) |
| Conventional SGA | O(N log N) | O(log N) |
| Embodiments | O(N) | O(log N) |

### H. Computer System

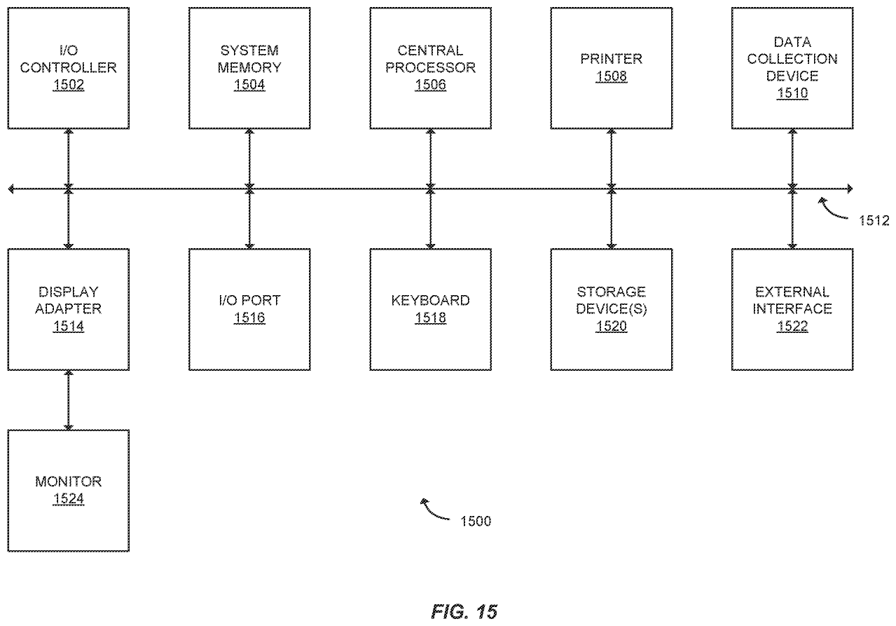

Any of the computer systems mentioned herein may utilize any suitable number of subsystems. Examples of such subsystems are shown in FIG. 15 in computer system 1500. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 15 are interconnected via a system bus 1512. Additional subsystems such as a printer 1508, keyboard 1518, storage device(s) 1520, monitor 1524 (e.g., a display screen, such as an LED), which is coupled to display adapter 1514, and others are shown. Peripherals and input/output (I/O) devices, which couple to I/O controller 1502, can be connected to the computer system by any number of means known in the art such as input/output (I/O) port 1516 (e.g., USB, FireWire®). For example, I/O port 1516 or external interface 1522 (e.g. Ethernet, Wi-Fi, etc.) can be used to connect computer system 1500 to a wide area network such as the Internet, a mouse input device, or a scanner. The interconnection via system bus 1512 allows the central processor 1506 to communicate with each subsystem and to control the execution of a plurality of instructions from system memory 1504 or the storage device(s) 1520 (e.g., a fixed disk, such as a hard drive, or optical disk), as well as the exchange of information between subsystems. The system memory 1504 and/or the storage device(s) 1520 may embody a computer readable medium. Another subsystem is a data collection device 1510, such as a camera, microphone, accelerometer, and the like. Any of the data mentioned herein can be output from one component to another component and can be output to the user.

A computer system can include a plurality of the same components or subsystems, e.g., connected together by external interface 1522, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

### I. References

[1] K. Nayak, X. S. Wang, S. Ioannidis, U. Weinsberg, N. Taft, and E. Shi, “Graphsc: Parallel secure computation made easy,” in 2015 IEEE Symposium on Security and Privacy. IEEE, 2015, pp. 377-394.
[2] K. Chida, K. Hamada, D. Ikarashi, R. Kikuchi, N. Kiribuchi, and B. Pinkas, “An efficient secure three-party sorting protocol with an honest majority.” LACR Cryptol. ePrint Arch., vol. 2019, p. 695, 2019.
[3] R. C. Rocha and B. D. Thatte, “Distributed cycle detection in large-scale sparse graphs,” Proceedings of Simpósio Brasileiro de Pesquisa Operacional (SBPO′15), pp. 1-11, 2015.
[4] G. Malewicz, M. H. Austern, A. J. Bik, J. C. Dehnert, I. Horn, N. Leiser, and G. Czajkowski, “Pregel: a system for large-scale graph processing,” in Proceedings of the 2010 ACM SIGMOD International Conference on Management of data, 2010, pp. 135-146.
[5] J. E. Gonzalez, Y. Low, H. Gu, D. Bickson, and C. Guestrin, “Powergraph: Distributed graph-parallel computation on natural graphs,” in 10^{th} {USENIX} Symposium on Operating Systems Design and Implementation ({OSDI} 12), 2012, pp. 17-30.
[6] Y. Low, J. Gonzalez, A. Kyrola, D. Bickson, C. Guestrin, and J. M. Hellerstein, “Distributed graphlab: A framework for machine learning and data mining in the cloud,” Proceedings of the VLDB Endowment, vol. 5, no. 8, 2012
[7] D. Bogdanov, S. Laur, and J. Willemson, “Sharemind: A framwork for fast privacy-preserving computations,” in European Symposium on Research in Computer Security. Springer, 2008, pp. 192-206.
[8] P. Rindal and P. Schoppmann, “Vole-psi: Fast oprf and circuit-psi from vector-ole,” in Annual International Conference on the Theory and Applications of Cryptographic Techniques. Springer, 2021, pp. 901-930.
[9] Y. Koren, R. Bell, and C. Volinsky, “Matrix factorization techniques for recommender systems,” Computer, vol. 42, no. 8, pp. 30-37, 2009.
[10] J. Bennet, S. Lanning et al., “The netflix prize,” in Proceedings of KDD cup and workshop, vol. 2007. New York, NY, USA., 2007, p. 35.
[11] P. Rindal, “The ABY³ Framework for Machine Learning and Database Operations.” https://github.com/ladnir/aby3.
[12] P. Rindal, “libOTe: an efficient, portable, and easy to use Oblivious transfer library,” https://github.com/osu-crypt/libOTe
[13] “CryptoTools,” https://github.com/ladnir/cryptoTools.
[14] T. Araki, J. Furukawa, Y. Lindell, A. Nof, and K. Ohara, “High-Throughput Semi-Honest Secure Three-Party Computation with an Honest Majority.” ACM CCS 2016.

1. A method of detecting money laundering, the method comprising performing, by a multi-party computation network:
receiving a secret-shared union tuple list from a first party computer and a second party computer, wherein the secret-shared union tuple list was generated using a first tuple list corresponding to first financial transfer data and the first party computer, and a second tuple list corresponding to second financial transfer data and the second party computer, and wherein the secret-shared union tuple list comprises a plurality of secret-shared union tuples corresponding to a representation of a union graph;
detecting one or more cycles in the secret-shared union tuple list by performing a multi-party computation on the secret-shared union tuple list, the one or more cycles comprising one or more directed cycles in the union graph; and
providing, to the first party computer and the second party computer, a notification of money laundering in response to detecting the one or more cycles.

2. The method of claim 1, wherein the notification of money laundering comprises a plaintext list of the one or more cycles.

3. The method of claim 1, wherein detecting the one or more cycles in the secret-shared union tuple list by performing the multi-party computation on the secret-shared union tuple list comprises performing a private multi-party Scatter-Gather-Apply implementation of a Rocha-Thatte cycle detection method, wherein the Rocha-Thatte cycle detection method is modified to assign a plurality of scatter probabilities to a plurality of secret-shared union edge tuples in the secret-shared union tuple list and wherein the Rocha-Thatte cycle detection method is additionally modified to restrict a maximum size of cycle detection messages to a predetermined value.

4. The method of claim 1, wherein the secret-shared union tuple list is generated by the first party computer and the second party computer using a private union garbled circuit protocol, wherein the private union garbled circuit protocol comprises a modified private set intersection garbled circuit protocol, the modified private set intersection garbled circuit protocol configured to produce a plurality of secret-shared disjoint tuples based on the first tuple list and the second tuple list, then combine the plurality of secret-shared disjoint tuples with either the first tuple list or the second tuple list, thereby generated the secret-shared union tuple list.

5. The method of claim 1, wherein the multi-party computation network comprises a three-party honest majority semi-honest multi-party computation network comprising a first computer, a second computer, and a third computer, and wherein the step of detecting the one or more cycles in the secret-shared union tuple list is performed by the first computer, the second computer, and the third computer using a three-party honest majority semi-honest multi-party implementation of a cycle detection method.

6. The method of claim 5, wherein the first party computer and the second party computer are members of the multi-party computation network, such that the first party computer is the first computer and the second party computer is the second computer.

7. The method of claim 1, wherein the secret-shared union tuple list comprises a plurality of secret-shared vertex tuples representing a plurality of vertices in the union graph and a plurality of secret-shared edge tuples representing a plurality of edges in the union graph.

8. The method of claim 7, further comprising:
generating a plurality of secret-shared duplicate edge tuples by duplicating the plurality of secret-shared edge tuples; and
including the plurality of secret-shared duplicate edge tuples in the secret-shared union tuple list.

9. The method of claim 1, wherein the secret-shared union tuple list comprises a plurality of secret-shared vertex tuples representing a plurality of vertices in the union graph, a plurality of secret-shared edge tuples representing a plurality of edges in the union graph, and a plurality of secret-shared duplicate edge tuples representing the plurality of edges in the union graph, wherein the plurality of secret-shared duplicate edge tuples were generated by the first party computer and the second party computer.

10. The method of claim 9, further comprising:
obliviously sorting the secret-shared union tuple list, thereby generating a first permutation corresponding to a first ordering, wherein the first permutation enables the multi-party computation network to order the secret-shared union tuple list according to the first ordering; and
obliviously sorting the secret-shared union tuple list, thereby generating a second permutation corresponding to a second ordering, wherein the second permutation enables the multi-party computation network to order the secret-shared union tuple list according to the second ordering.

11. The method of claim 10, wherein:
in the first ordering, each secret-shared vertex tuple of the plurality of secret-shared vertex tuples in the secret-shared union tuple list is preceded by one or more corresponding secret-shared edge tuples of the plurality of secret-shared edge tuples and followed by one or more corresponding secret-shared duplicate edge tuples of the plurality of secret-shared duplicate edge tuples; and
in the second ordering, each secret-shared vertex tuple of the plurality of secret-shared vertex tuples in the secret-shared union tuple list is preceded by one or more corresponding secret-shared duplicate edge tuples of the plurality of secret-shared duplicate edge tuples and followed by one or more corresponding secret-shared edge tuples of the plurality of secret-shared edge tuples.

12. The method of claim 10, wherein detecting the one or more cycles in the secret-shared union tuple list by performing the multi-party computation on the secret-shared union tuple list comprises an iterative process comprising:
(1) obliviously shuffling the secret-shared union tuple list into the first ordering using the first permutation;
(2) performing a combined Scatter-Gather step on the secret-shared union tuple list;
(3) performing an Apply step on the secret-shared union tuple list;
(4) obliviously shuffling the secret-shared union tuple list into the second ordering using the second permutation;
(5) performing the combined Scatter-Gather step on the secret-shared union tuple list;
(6) performing the Apply step on the secret-shared union tuple list; and
(7) repeating steps (1)-(6) until a terminating condition has been achieved, wherein the one or more cycles are determined in response to achieving the terminating condition.

13. The method of claim 12, wherein the combined Scatter-Gather step and the apply step are performed based on a plurality of tuple states, the plurality of tuple states indicating whether each tuple of the plurality of secret-shared union tuples comprises a vertex tuple, an edge tuple, or a duplicate edge tuple, and wherein the method of detecting money laundering further comprises determining the plurality of tuple states.

14. The method of claim 12, wherein the combined Scatter-Gather step comprises:
defining a set of inputs comprising the plurality of secret-shared union tuples in the secret-shared union tuple list;
an upward pass comprising:
(a) dividing the set of inputs among a plurality of processors;
(b) processing the set of inputs using a cycle detection method and based on a current ordering of the secret-shared union tuple list using the plurality of processors, thereby producing a first set of outputs, wherein the first set of outputs comprises less outputs than the set of inputs comprises inputs;
(c) defining the set of inputs as the first set of outputs;
(d) repeating the upward pass until the set of inputs comprises a single input; and a downward pass comprising:
(f) dividing the set of inputs among the plurality of processors;
(g) processing the set of inputs using the cycle detection method and based on the current ordering of the secret-shared union tuple list using the plurality of processors, thereby producing a second set of outputs, wherein the second set of outputs comprises more outputs than the set of inputs comprises inputs; and
(h) repeating the downward pass until the set of inputs comprises an updated plurality of union tuples in the secret-shared union tuple list.

15. The method of claim 14, wherein the Apply step comprises:
(i) dividing the updated plurality of union tuples among the plurality of processors; and
(j) applying an apply function to each tuple of the updated plurality of union tuples using the plurality of processors, wherein the apply function produces an output if the terminating condition has been achieved.

16. A method comprising performing, by a multi-party computation network:
receiving a secret-shared union tuple list from a first party computer and a second party computer, wherein the secret-shared union tuple list was generated using a first tuple list corresponding to the first party computer, and a second tuple list corresponding to the second party computer, and wherein the secret-shared union tuple list comprises a representation of a union graph;
generating a first permutation corresponding to a first ordering and a second permutation corresponding to a second ordering, wherein the first permutation enables the multi-party computation network to order the secret-shared union tuple list according to the first ordering, and wherein the second permutation enables the multi-party computation network to order the secret-shared union tuple list according to the second ordering;
defining a set of inputs as a plurality of secret-shared union tuples in the secret-shared union tuple list;
executing a parallel private graph method using an iterative Scatter-Gather-Apply approach, the iterative Scatter-Gather-Apply approach comprising an upward pass, a downward pass, and an apply step;
the upward pass comprising:
(1) dividing the set of inputs among a plurality of processors;
(2) processing the set of inputs based on a current ordering of the secret-shared union tuple list using the plurality of processors, thereby producing a set of outputs, wherein the set of outputs comprises less outputs than the set of inputs comprises inputs;
(3) defining the set of inputs as the set of outputs;
(4) repeating the upward pass until the set of inputs comprises a single input;
the downward pass comprising:
(5) dividing the set of inputs among the plurality of processors;
(6) processing the set of inputs based on the current ordering of the secret-shared union tuple list using the plurality of processors, thereby producing the set of outputs, wherein the set of outputs comprises more outputs than the set of inputs comprises inputs;
(7) defining the set of inputs as the set of outputs;
(8) repeating the downward pass until the set of inputs comprises an updated plurality of union tuples in the secret-shared union tuple list;
the apply step comprising:
(9) dividing the updated plurality of union tuples among the plurality of processors;
(10) applying an apply function to each tuple of the updated plurality of union tuples using the plurality of processors, wherein the apply function produces a result of the parallel private graph method when a terminating condition has been achieved, the terminating condition indicating that the parallel private graph method has been completed;
(11) determining the terminating condition has not been achieved;
if the secret-shared union tuple list is in the first ordering, oblivious shuffling the secret-shared union tuple list into the second ordering using the second permutation, otherwise oblivious shuffling the secret-shared union tuple list into the first ordering using the first permutation; and
repeating the iterative Scatter-Gather-Apply approach until the terminating condition has been achieved.

17. The method of claim 16, further comprising determining whether the terminating condition has been achieved by evaluating data associated with the updated plurality of union tuples.

18. (canceled)

19. The method of claim 16, wherein the parallel private graph method comprises a Rocha-Thatte cycle detection method, and wherein the result of the parallel private graph method comprises a list of one or more cycles corresponding to the union graph.

20. The method of claim 19, wherein the union graph comprises a union financial transfer graph corresponding to first party financial transfer data corresponding to the first party computer and second party financial transfer data corresponding to the second party computer, wherein the list of one or more cycles corresponding to the union graph comprises one or more cyclical payments comprising evidence of money laundering, and wherein the method further comprises outputting a notification of money laundering.

21. A computer comprising:
one or more processors; and
a non-transitory computer readable medium coupled to the one or more processors, the non-transitory computer readable medium comprising code that, when executed, cause the one or more processors to perform a method of detecting money laundering, the method comprising:
receiving a secret-shared union tuple list from a first party computer and a second party computer, wherein the secret-shared union tuple list was generated using a first tuple list corresponding to first financial transfer data and the first party computer, and a second tuple list corresponding to second financial transfer data and the second party computer, and wherein the secret-shared union tuple list comprises a plurality of secret-shared union tuples corresponding to a representation of a union graph;
detecting one or more cycles in the secret-shared union tuple list by performing a multi-party computation on the secret-shared union tuple list, the one or more cycles comprising one or more directed cycles in the union graph; and
providing, to the first party computer and the second party computer, a notification of money laundering in response to detecting the one or more cycles.

22. (canceled)
